(19) United States
(12) Patent Application Publication
(10) Pub. No.: US 2013/0243077 A1
(43) Pub. Date: Sep. 19, 2013

(54) METHOD AND APPARATUS FOR PROCESSING MOVING IMAGE INFORMATION, AND METHOD AND APPARATUS FOR IDENTIFYING MOVING IMAGE PATTERN

(71) Applicant: CANON KABUSHIKI KAISHA, Tokyo (JP)

(72) Inventor: Yusuke Mitarai, Tokyo (JP)

(73) Assignee: CANON KABUSHIKI KAISHA, Tokyo (JP)

(21) Appl. No.: 13/792,519

(22) Filed: Mar. 11, 2013

(30) Foreign Application Priority Data
Mar. 13, 2012 (JP) 2012-055625

(51) Int. Cl. H04N 7/26

(52) U.S. Cl. CPC H04N 19/00903
USPC 375/240.01

(57) ABSTRACT

A moving image information processing method according to the present invention includes receiving moving image data and extracting time-sequential data of local features from the moving image data. The method further includes receiving at least one time-sequential data transition model relating to the extracted time-sequential data and generating description data of the input moving image data, based on the extracted time-sequential data and the time-sequential data transition model.

### BACKGROUND OF THE INVENTION

1. Field of the Invention

The present invention relates to a moving image data description method and a moving image pattern identification method using the description method.

2. Description of the Related Art

A moving image data description method capable of identifying a moving image pattern is, for example, discussed in Japanese Patent No. 4061377, in which moving image data can be described using cubic higher-order local autocorrelation features. Further, a moving image data description method discussed in “Ivan Laptev, “On Space-Time Interest Points”, International Journal of Computer Vision, Vol. 64, No. 2, pp. 107-123, September 2005” includes detecting a spatiotemporal key point from moving image data and describing the moving image data using spatiotemporally neighboring data positioned near the detected point.

Further, a method discussed in Japanese Patent Application Laid-Open No. 2009-122829 does not process any moving image data as volume data. More specifically, the conventional method includes extracting time-sequential data of a macro feature quantity (e.g., a movement amount) from the moving image data. The method further includes describing the moving image data as a vector that represents an array of likelihood values of the extracted time-sequential data in a plurality of probability models, together with non-time-sequential feature quantities. In this case, it is useful to use hidden Markov models discussed in “Elliott, R. J., L. Aggoun, and J. B. Moore, “Hidden Markov Models: Estimation and Control”, 1995” as the above-mentioned plurality of probability models, because it becomes feasible to realize a moving image data description having appropriate robustness against nonlinear expansion/compression in the time direction.

However, according to the methods discussed in the Japanese Patent No. 4061377 and “Ivan Laptev, “On Space-Time Interest Points”, International Journal of Computer Vision, Vol. 64, No. 2, pp. 107-123, September 2005”, the moving image data is processed as three-dimensional volume data (e.g., two dimensions+time axis) in the description of the moving image data. Therefore, the robustness against the nonlinear expansion/compression in the time direction is insufficient.

Further, even when the method discussed in Japanese Patent Application Laid-Open No. 2009-122829 is combined with the method discussed in “Elliott, R. J., L. Aggoun, and J. B. Moore, “Hidden Markov Models: Estimation and Control”, 1995”, it is difficult to describe a complicated moving image data in detail by using the time-sequential data of the macro feature quantity (e.g., the movement amount).

As mentioned above, to achieve the goal of identifying the moving image pattern, it is required to provide a novel moving image data description method that is robust against the nonlinear expansion/compression in the time direction and can describe the complicated moving image data in detail.

### SUMMARY OF THE INVENTION

The present invention is directed to a technique that is robust against the nonlinear expansion/compression in the time direction and is capable of generating description data that can describe a complicated moving image data in detail.

A moving image information processing method according to the present invention includes receiving a moving image data and extracting time-sequential data of local features from the moving image data. The method further includes receiving at least one time-sequential data transition model that relates to the extracted time-sequential data and generating description data of the received moving image data based on the extracted time-sequential data and the time-sequential data transition model.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a processing configuration of a moving image pattern identification method according to a first exemplary embodiment of the present invention.

FIG. 2 is a flowchart illustrating example processing of the moving image pattern identification method according to the first exemplary embodiment of the present invention.

FIG. 3 illustrates a processing configuration of a time-sequential data transition model generation method according to the first exemplary embodiment of the present invention.

FIG. 4 is a flowchart illustrating example processing of the time-sequential data transition model generation method according to the first exemplary embodiment of the present invention.

FIG. 5 illustrates a processing configuration of a moving image pattern identification method according to a second exemplary embodiment of the present invention.

FIG. 6 is a flowchart illustrating example processing of the moving image pattern identification method according to the second exemplary embodiment of the present invention.

FIG. 7 illustrates an example of a displacement feature determination standard according to the second exemplary embodiment of the present invention.

FIG. 8 illustrates a processing configuration of a type “2” time-sequential data transition model generation method according to the second exemplary embodiment of the present invention.

FIG. 9 is a flowchart illustrating example processing of the type “2” time-sequential data transition model generation method according to the second exemplary embodiment of the present invention.

FIG. 10 illustrates a processing configuration of a moving image data clustering method according to a third exemplary embodiment of the present invention.

FIG. 11 is a flowchart illustrating example processing of the moving image data clustering method according to the third exemplary embodiment of the present invention.

FIG. 12 is a flowchart illustrating example processing that can be performed by a K-medoids clustering unit according to the third exemplary embodiment of the present invention.

### DESCRIPTION OF THE EMBODIMENTS

Various exemplary embodiments, features, and aspects of the invention will be described in detail below with reference to the drawings.

An example of a moving image information processing method according to a first exemplary embodiment of the present invention includes receiving moving image data and generating description data of the received moving image data. Further, an example of a moving image pattern identification method according to the first exemplary embodiment of the present invention includes identifying whether the moving image data belongs to a predetermined category C based on the generated description data. In the present exemplary embodiment, input moving image data is a four-second moving image of an arbitrary sports scene. The input moving image data has an image size of 320×240 pixels and includes 60 frames in total (=15 frames per second×four seconds). In the present exemplary embodiment, the predetermined category C is the type of specific sports (e.g., soccer or baseball). The method includes determining whether the input moving image data belongs to the category C.

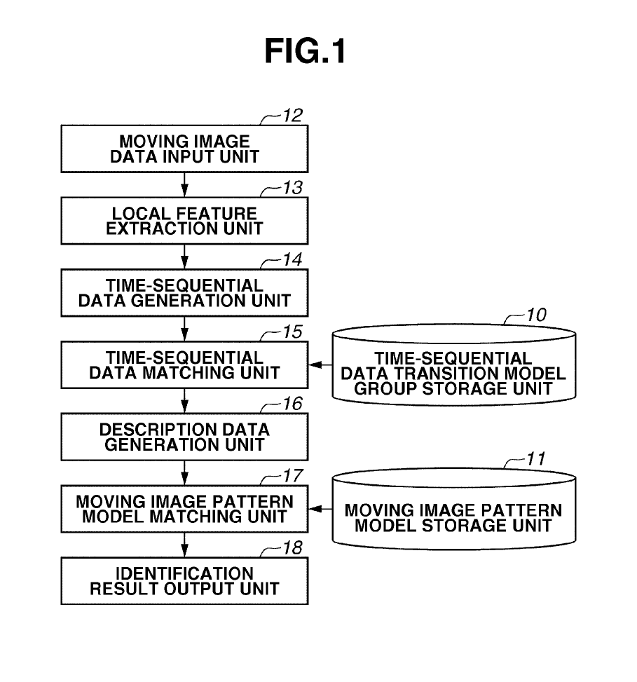

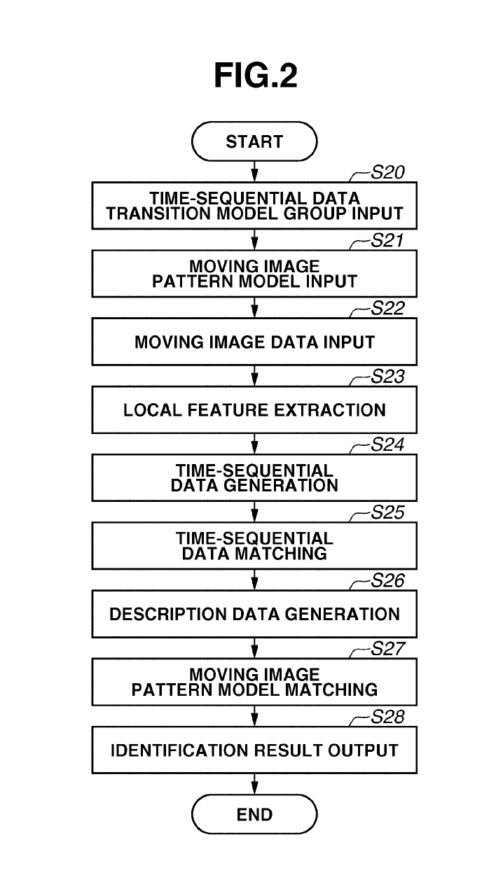

FIG. 1 is a block diagram illustrating a moving image pattern identification method according to the first exemplary embodiment of the present invention. FIG. 2 is a flowchart illustrating example processing of the moving image pattern identification method according to the present exemplary embodiment. An example of the moving image pattern identification method according to the present exemplary embodiment is described in detail below with reference to FIGS. 1 and 2.

A time-sequential data transition model group storage unit 10 is a data storage unit configured to store numerous time-sequential data transition model groups. The Hidden Markov Model (HMM) is an example time-sequential data transition model usable in the present exemplary embodiment.

Although described in detail below, continuous value data are used as HMM observation time-sequential data in the present exemplary embodiment. Therefore, an emission probability function of the HMM data used in the present exemplary embodiment is a probability density function that uses continuous variables as a domain. The time-sequential data transition model group storage unit 10 can receive and store at least one HMM data. In the present exemplary embodiment, the time-sequential data transition model group storage unit 10 receives and stores 400 pieces of HMM data while allocating indices of HMM1, HMM2, . . . , and HMM400 to respective HMM data, although the order of the indices can be arbitrarily determined. The processing to be performed by the time-sequential data transition model group storage unit 10 corresponds to a time-sequential data transition model group input step S20 illustrated in FIG. 2. The HMM data to be input in this case is HMM data generated beforehand. An example of the HMM data generation method is described in detail below.

The time-sequential data transition models used in the present exemplary embodiment are the HMM data. However, the present invention is not limited to the above-mentioned example. For example, any other models are usable if the data of a predetermined time has a dependence relationship with past data in the same time-sequential data. In this respect, ordinary Markov models or DP matching models, for example discussed in non-patent literature document entitled “Connected Digit Recognition Using a Level-Building DTW Algorithm”, by Cory S. Myers and Lawrence R. Rabiner, IEEE Transactions on Acoustics, Speech, and Signal Processing, Vol. 29, No. 3, pp. 351-363, June 1981, are usable.

A moving image pattern model storage unit 11 is a data storage unit configured to store moving image pattern models that belong to a predetermined category. In the present exemplary embodiment, the class-featuring information compression (CLAFIC) method, which is one of the subspace methods, is usable as an example method for identifying whether moving image data belongs to the predetermined category C. For example, the CLAFIC method is described in non-patent literature document entitled “Subspace Method in Pattern Recognition”, by Watanabe, S. and N. Pakvasa, Proceedings International Conference in Pattern Recognition, pp. 2-32, 1973.

Therefore, in the present exemplary embodiment, the moving image pattern model storage unit 11 receives and stores the moving image pattern subspace model data generated using the moving image data that belongs to the predetermined category C. The processing to be performed by the moving image pattern model storage unit 11 corresponds to a moving image pattern model input step S21 illustrated in FIG. 2. An example method for generating the subspace model data to be stored is described in detail below. An example method for identifying whether the moving image data belongs to the predetermined category C used in the present exemplary embodiment is the CLAFIC method. However, the present invention is not limited to the above-mentioned example. For example, any other conventional identification method, such as Support Vector Machine (SVM), is usable.

A moving image data input unit 12 is a processing unit configured to receive moving image data of an identification target to check whether the target belongs to the predetermined category C. As mentioned above, in the present exemplary embodiment, the moving image data input unit 12 inputs moving image data of 60 frames each having an image size of 320×240 pixels. The processing to be performed by the moving image data input unit 12 corresponds to a moving image data input step S22 illustrated in FIG. 2.

A local feature extraction unit 13 is a processing unit configured to perform processing for extracting local features at a plurality of fixed points on each frame image, which is applied to the moving image data received via the moving image data input unit 12. In the present exemplary embodiment, the fixed points are a plurality of points disposed at intervals of five pixels in such a way as to form a grid pattern on the image. The local feature extraction unit 13 extracts local features corresponding to each fixed point with reference to image data of a local area having the center at each fixed point.

The local features to be extracted in the present exemplary embodiment are Histograms of Oriented Gradients (HOG) features. In the present exemplary embodiment, the HOG features to be extracted are 81-dimensional data that can be calculated using image data of a local area that has the center at the fixed point and includes 27×27 pixels. The moving image data according to the present exemplary embodiment has an image size of 320×240 pixels and includes 60 frames in total. The extraction of HOG features is performed at intervals of five pixels on the image, except for a peripheral region of the image that cannot be extracted as a local area including 27×27 pixels. Accordingly, the local feature extraction unit 13 extracts approximately 150 thousands of HOG features. The processing to be performed by the local feature extraction unit 13 corresponds to a local feature extraction step S23 illustrated in FIG. 2. As mentioned above, the local features to be extracted in the present exemplary embodiment are HOG features. However, the present invention is not limited to the above-mentioned example. For example, any other features (e.g., SIFT features) are usable if the feature quantity can describe local information of the image.

Further, instead of extracting the features from a two-dimensional image of one frame, it is also useful to extract local features from a spatiotemporal local area, such as three-dimensional local Jet features discussed in “Ivan Laptev, “On Space-Time Interest Points”, International Journal of Computer Vision, Vol. 64, No. 2, pp. 107-123, September 2005”.

A time-sequential data generation unit 14 is a processing unit configured to generate a plurality of pieces of time-sequential data based on numerous local features extracted by the local feature extraction unit 13. In the present exemplary embodiment, the time-sequential data generation unit 14 generates one piece of time-sequential data for each of the above-mentioned fixed points. In the present exemplary embodiment, the time-sequential data at each fixed point are time-sequentially obtained and disposed differences between local features of two neighboring frames (i.e., HOG features). The time-sequentially disposed differences of HOG features are HMM observation time-sequential data in the present exemplary embodiment.

The moving image data according to the present exemplary embodiment includes 60 frames as mentioned above and the differences between frames of the HOG features are time-sequentially disposed. Therefore, one piece of time-sequential data includes difference data of 59 HOG features. The time-sequential data generation unit 14 performs processing for obtaining the above-mentioned time-sequential data for all of the above-mentioned fixed points.

The processing to be performed by the time-sequential data generation unit 14 corresponds to a time-sequential data generation step S24 illustrated in FIG. 2.

In the present exemplary embodiment, the fixed points are positioned at intervals of five pixels, as mentioned above. Therefore, approximately 2500 pieces of time-sequential data can be generated through the above-mentioned processing. In the present exemplary embodiment, the time-sequential data is time-sequentially disposed difference data of the local features. Alternatively, the time-sequential data can be time-sequentially disposed local features. Further, for example, the PCA dimension reduction method discussed in non-patent literature document entitled “Principal Component Analysis (Second Edition)”, by I. T. Jolliffe, Springer Series in Statistics, 2002, is usable to reduce the dimension of the local features.

A time-sequential data matching unit 15 is a processing unit configured to perform matching of the time-sequential data generated by the time-sequential data generation unit 14 and the time-sequential data transition models stored in the time-sequential data transition model group storage unit 10. In the present exemplary embodiment, the time-sequential data matching unit 15 performs matching of each of all the time-sequential data generated by the time-sequential data generation unit 14 and all time-sequential data transition models stored in the time-sequential data transition model group storage unit 10. Then, the time-sequential data matching unit 15 performs processing for identifying a time-sequential data transition model that most closely matches each time-sequential data. The processing to be performed by the time-sequential data matching unit 15 corresponds to a time-sequential data matching step S25 illustrated in FIG. 2.

The time-sequential data transition model used in the present exemplary embodiment is HMM. Therefore, the matching performed by the time-sequential data matching unit 15 is processing for obtaining likelihoods with respect to HMM time-sequential data. Therefore, the time-sequential data matching unit 15 obtains an index of the HMM data that has the highest likelihood, which is one of the HMM data (i.e., HMM1 to HMM400). If the matching result indicates that there is not any matched time-sequential data transition model, the time-sequential data matching unit 15 can determine that no time-sequential data transition model matches the presently processed time-sequential data.

A description data generation unit 16 is configured to perform processing for generating description data that describes the moving image data received via the moving image data input unit 12 based on the processing result obtained by the time-sequential data matching unit 15.

More specifically, the description data generation unit 16 obtains the number of the most closely matched time-sequential data for each time-sequential data transition model and generates frequency data that includes an array of the obtained numbers. The description data generation unit 16 designates the generated frequency data as the description data of the moving image data received via the moving image data input unit 12.

For example, it is now presumed that the processing result indicates that ten pieces of time-sequential data most closely matched the first time-sequential data transition model. The number of time-sequential data that most closely matched the second time-sequential data transition model is 0. Further, the number of time-sequential data that most closely matched the third time-sequential data transition model is 4. The processing result further indicates numerical values for other time-sequential data transition models. In this case, the frequency data to be generated by the description data generation unit 16 is an array of numerical values (i.e., 10, 0, 4, . . . ) that correspond to the total number of the time-sequential data transition models.

In the present exemplary embodiment, the total number of the time-sequential data transition models is 400. Therefore, the frequency data to be generated by the description data generation unit 16 is an array of 400 numerical values. The generated frequency data is designated as the description data of the moving image data received via the moving image data input unit 12. The processing to be performed by the description data generation unit 16 corresponds to a description data generation step S26 illustrated in FIG. 2.

A moving image pattern model matching unit 17 is a processing unit configured to perform matching of the description data generated by the description data generation unit 16 and the moving image pattern models stored in the moving image pattern model storage unit 11. The processing to be performed by the moving image pattern model matching unit 17 corresponds to a moving image pattern model matching step S27 illustrated in FIG. 2. In the present exemplary embodiment, the above-mentioned CLAFIC method is usable to perform the identification processing. Therefore, the description data generated by the description data generation unit 16 can be regarded as a multi-dimensional vector. The moving image pattern model matching unit 17 performs processing for calculating an angle formed between the multi-dimensional vector and the moving image pattern model (i.e., subspace model).

A subspace model generation method according to the present exemplary embodiment is described in detail below. Numerous moving image data that belong to the predetermined category C are used in the subspace model generation. The format of the moving image data used in the present exemplary embodiment is similar to that of the moving image data received via the moving image data input unit 12. More specifically, in the present exemplary embodiment, the moving image data has an image size of 320×240 pixels and includes 60 frames in total. N pieces (e.g., 100 pieces) of moving image data that belong to the category C are used.

First, the method includes generating description data of each moving image data by subjecting each of the above-mentioned N pieces of moving image data that belong to the category C to the above-mentioned sequential processing performed by the local feature extraction unit 13 to the description data generation unit 16. The method further includes obtaining an auto-correlation matrix R=1/N·Σx(i)x(i)T based on each of the generated description data that can be regarded as a multi-dimensional vector x(i) {i=1, 2, . . . , N}.

Then, the method includes obtaining eigenvalues and eigenvectors of the auto-correlation matrix R. The method includes obtaining an orthogonal projection matrix P in a k-dimensional subspace that can be defined by eigenvectors es(j) {j=1, 2, . . . , k} that correspond to k eigenvalues having larger values.

The orthogonal projection matrix P serves as the subspace model in the present exemplary embodiment. The dimension “k” of the subspace can be set to an optimum value with reference to the moving image data that belong to the category C used in the generation of the subspace model and numerous validation dataset that include moving image data belonging to a category other that the category C, and considering identification performance relative to the validation dataset. As mentioned above, the generated subspace model (i.e., the above-mentioned orthogonal projection matrix P) is stored in the moving image pattern model storage unit 11 and can be used when the moving image pattern model matching unit 17 performs the above-mentioned processing.

An identification result output unit 18 is configured to perform processing for determining whether the input moving image data belongs to the predetermined category C based on the matching result obtained by the moving image pattern model matching unit 17 and outputting a determination result.

In the present exemplary embodiment, the identification result output unit 18 determines whether the input moving image data belongs to the predetermined category C based on the angle formed between the subspace model and the multi-dimensional vector calculated by the moving image pattern model matching unit 17. More specifically, if it is determined that the angle formed between the subspace model and the vector calculated by the moving image pattern model matching unit 17 is less than a predetermined angle, the identification result output unit 18 determines that the input moving image data belongs to the predetermined category C. If it is determined that the angle is equal to or greater than the predetermined angle, the identification result output unit 18 determines that the input moving image data does not belong to the predetermined category C.

The entire processing of the moving image pattern identification method according to the present exemplary embodiment terminates upon completing the output of the determination result. The processing to be performed by the identification result output unit 18 corresponds to an identification result output step S28 illustrated in FIG. 2. The predetermined angle to be referred to in determining whether the input moving image data belongs to the category C can be set to an experimentally obtained value that can minimize the possibility of erroneously determining the validation dataset, based on the validation dataset used in setting the k-dimensional subspace, in the generation of the above-mentioned subspace model.

When the above-mentioned processing is performed, it becomes feasible to determine whether the input moving image data belongs to the predetermined category C. As mentioned above, the moving image pattern identification method according to the present invention includes first extracting numerous time-sequential data from the moving image data and then obtaining a time-sequential data transition model that most closely matches each time-sequential data.

Then, the method designates the frequency of the matched time-sequential data transition model as description data of the presently processed moving image data. Finally, the method includes determining whether the input moving image data belongs to a predetermined category by performing matching of the description data and moving image pattern models that belong to the predetermined category.

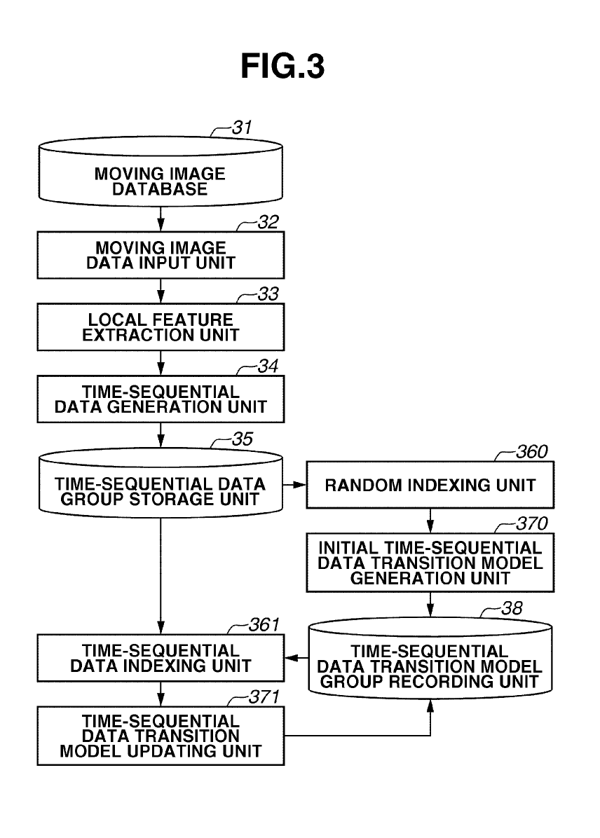

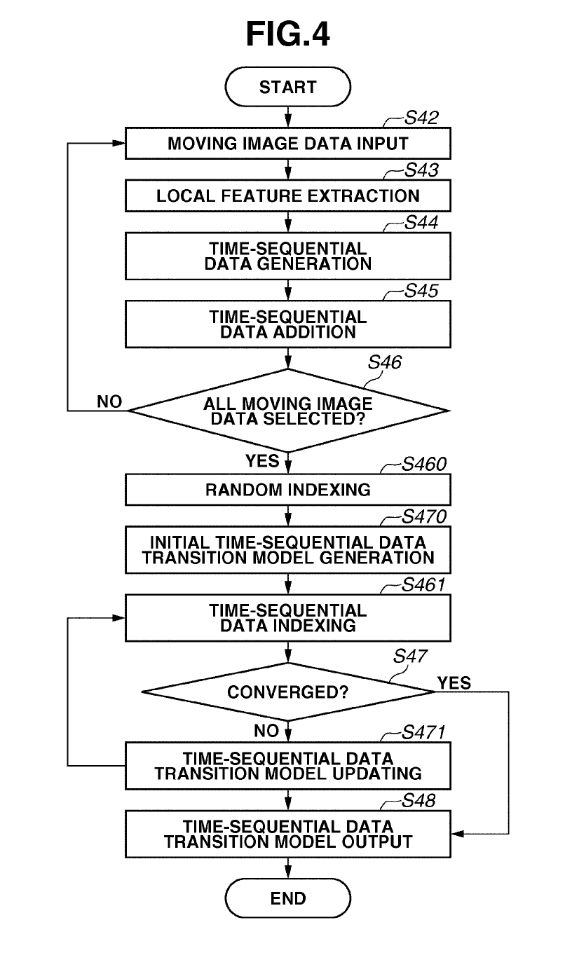

Next, an example time-sequential data transition model generation method is described in detail below with reference to a processing block diagram of the time-sequential data transition model generation method illustrated in FIG. 3 and a processing flowchart of the time-sequential data transition model generation method illustrated in FIG. 4.

First, a moving image database 31 is a data storage unit configured to store numerous moving image data beforehand. The numerous moving image data stored in the moving image database 31 can be arbitrary moving image data. In the present exemplary embodiment, the format of the moving image data is similar to that of the moving image data to be subjected to the processing of the above-mentioned identification method. More specifically, the moving image data used in the present exemplary embodiment are moving image data of various sport scenes that have an image size of 320×240 pixels and includes 60 frames in total.

A moving image data input unit 32 illustrated in FIG. 3 is configured to receive one piece of moving image data, which can be selected from the moving image data stored in the moving image database 31. The moving image data input unit 32 can receive moving image data one by one that are selected in any order. The processing to be performed by the moving image data input unit 32 corresponds to a moving image data input step S42 illustrated in FIG. 4.

A local feature extraction unit 33 and a time-sequential data generation unit 34 illustrated in FIG. 3 are processing units similar to the local feature extraction unit 13 and the time-sequential data generation unit 14 illustrated in FIG. 1, which are configured to perform processing for generating numerous time-sequential data based on input moving image data. The content of the above-mentioned processing is similar to the above-mentioned content and therefore redundant description thereof will be avoided. The processing to be performed by the local feature extraction unit 33 and the time-sequential data generation unit 34 corresponds to a local feature extraction step S43 and a time-sequential data generation step S44 illustrated in FIG. 4.

A time-sequential data group storage unit 35 illustrated in FIG. 3 is configured to cumulatively record numerous time-sequential data, which are generated when the time-sequential data generation unit 34 performs the above-mentioned processing. The processing to be performed by the time-sequential data group storage unit 35 corresponds to a time-sequential data addition step S45 illustrated in FIG. 4. The time-sequential data group storage unit 35 sequentially executes the above-mentioned processing for all moving image data stored in the moving image database 31 and repeats the recording to complete the processing for all moving image data (i.e., YES in step S46). As a result, various or numerous time-sequential data can be stored in the time-sequential data group storage unit 35.

A random indexing unit 360 is configured to perform processing for randomly allocating a time-sequential data transition model index to each of the numerous time-sequential data stored in the time-sequential data group storage unit 35. The processing to be performed by the random indexing unit 360 corresponds to a random indexing step S460 illustrated in FIG. 4.

The total number of the time-sequential data transition models generated in the present exemplary embodiment is 400. Therefore, the random indexing unit 360 randomly allocates 1 to 400, as indices, to respective time-sequential data. Any arbitrary method is usable to realize the above-mentioned random allocation. In the present exemplary embodiment, uniform pseudo-random numbers in the range from 1 to 400 are usable to realize the above-mentioned allocation in such a way as to equalize the number of time-sequential data that correspond to each index.

An initial time-sequential data transition model generation unit 370 is configured to generate an initial time-sequential data transition model group and record the generated initial time-sequential data transition model group in a time-sequential data transition model group recording unit 38. In the present exemplary embodiment, the initial time-sequential data transition model generation unit 370 generates initial time-sequential data transition models that correspond to each index using an assembly of time-sequential data that are identical in the index allocated by the random indexing unit 360. More specifically, for example, the initial time-sequential data transition model generation unit 370 uses a plurality of pieces of time-sequential data to which index i is allocated. The initial time-sequential data transition model generation unit 370 generates time-sequential data transition models that simulate these time-sequential data, as the initial time-sequential data transition models that correspond to the index i. The processing to be performed by the initial time-sequential data transition model generation unit 370 corresponds to an initial time-sequential data transition model generation step S470 illustrated in FIG. 4.

The time-sequential data transition models used in the present exemplary embodiment are HMM data. Therefore, the initial time-sequential data transition model generation unit 370 generates HMM data with reference to a plurality of pieces of time-sequential data having the same index.

More specifically, first, the initial time-sequential data transition model generation unit 370 randomly initializes HMM model parameters. Then, the initial time-sequential data transition model generation unit 370 updates the HMM model parameters with the initialized parameter values, according to the EM algorithm, using a plurality of pieces of time-sequential data to which a corresponding index is allocated. In performing the above-mentioned processing for updating the model parameters, the initial time-sequential data transition model generation unit 370 can repeat the E step and the M step until an expected value of the logarithmic likelihood converges, in the same manner as the ordinary HMM processing.

However, the plurality of pieces of time-sequential data used in the present exemplary embodiment are randomly allocated beforehand. Therefore, the initial time-sequential data transition model generation unit 370 can perform the above-mentioned parameter updating processing only several times (e.g., once or twice) without excessively fitting the parameters. As mentioned above, the initial time-sequential data transition model generation unit 370 records the generated HMM data that correspond to each index, more specifically, HMM model parameters, in the time-sequential data transition model group recording unit 38.

A time-sequential data indexing unit 361 is similar to the random indexing unit 360. More specifically, the time-sequential data indexing unit 361 is configured to perform processing for allocating a time-sequential data transition model index to each of the numerous time-sequential data stored in the time-sequential data group storage unit 35. However, processing to be performed by the time-sequential data indexing unit 361 is different from the processing performed by the random indexing unit 360 in that the index is allocated to each time-sequential data based on a result of matching of each time-sequential data with a plurality of time-sequential data transition models recorded in the time-sequential data transition model group recording unit 38.

More specifically, similar to the processing of the time-sequential data matching unit 15 illustrated in FIG. 1, first, the time-sequential data indexing unit 361 performs matching of each time-sequential data and all time-sequential data transition models stored in the time-sequential data transition model group recording unit 38. Then, the time-sequential data indexing unit 361 allocates an index that corresponds to the most closely matched time-sequential data transition model to each time-sequential data. The processing to be performed by the time-sequential data indexing unit 361 corresponds to a time-sequential data indexing step S461 illustrated in FIG. 4. The time-sequential data transition models used in the present exemplary embodiment are the HMM data. Therefore, the time-sequential data indexing unit 361 obtains a likelihood of each HMM relative to each time-sequential data and allocates an index that corresponds to the HMM having the highest likelihood to the presently processed time-sequential data.

Through the above-mentioned processing performed by the time-sequential data indexing unit 361, an index is newly allocated to each time-sequential data. At a determination step S462, it is determined whether the time-sequential data transition model generation processing has been converged.

More specifically, if a newly allocated index of each time-sequential data coincides with the previously allocated index, it is determined that the generation processing has been converged. If the newly allocated index does not coincide with the previously allocated index, it is determined that the generation processing is not yet converged. When the generation processing is not yet converged, the operation proceeds to processing to be performed by a time-sequential data transition model updating unit 371. The time-sequential data transition model updating unit 371 repetitively performs the processing in the time-sequential data indexing unit 361 and the time-sequential data transition model updating unit 371 until it is determined that the generation processing has been converged.

The time-sequential data transition model updating unit 371 performs processing for updating the time-sequential data transition model that corresponds to each index, using an assembly of time-sequential data that have the same index allocated by the time-sequential data indexing unit 361. In the present exemplary embodiment, the time-sequential data transition model updating unit 371 obtains time-sequential data transition models to simulate the plurality of pieces of time-sequential data having the same index, and updates the time-sequential data transition models having the corresponding index recorded in the time-sequential data transition model group recording unit 38. The processing to be performed by the time-sequential data transition model updating unit 371 corresponds to a time-sequential data transition model updating step S471 illustrated in FIG. 4.

In the present exemplary embodiment, similar to the initial time-sequential data transition model generation unit 370, the time-sequential data transition model updating unit 371 performs processing for updating HMM model parameters according to the EM algorithm using a plurality of pieces of time-sequential data to which the corresponding index is allocated. Although the initial time-sequential data transition model generation unit 370 randomly sets the initial values of the model parameters, the initial values set by the time-sequential data transition model updating unit 371 are HMM model parameters having the corresponding index, which are recorded in the time-sequential data transition model group recording unit 38.

Further, instead of performing the updating processing according to the EM algorithm only several times, the time-sequential data transition model updating unit 371 repeats the E step and the M step until an expected value of the logarithmic likelihood converges and repetitively performs the model parameter updating processing. Then, the time-sequential data transition model updating unit 371 sets the model parameters obtained after the expected value of the logarithmic likelihood has converged as new time-sequential data transition models and updates the time-sequential data transition models having the corresponding index, which are recorded in the time-sequential data transition model group recording unit 38.

On the other hand, if it is determined that the generation processing has been converged after the processing of the time-sequential data indexing unit 361, the time-sequential data transition model updating unit 371 outputs the plurality of time-sequential data transition models stored in the time-sequential data transition model group recording unit 38 as final time-sequential data transition models. The processing to be performed by the time-sequential data transition model updating unit 371 in this case corresponds to a time-sequential data transition model output step S48 illustrated in FIG. 4. The entire processing of the time-sequential data transition model generation method terminates upon completing the output of the final time-sequential data transition models.

The above-mentioned processing can acquire a plurality of time-sequential data transition models, which correspond to Visual Codewords that relate to the time-sequential data discussed in non-patent literature document entitled “Visual Categorization with Bags of Keypoints”, by Csurka, G., C. Bray, C. Dance and L. Fan, ECCV Workshop on Statistical Learning in Computer Vision, pp. 1-22, 2004.

When the above-mentioned plurality of time-sequential data transition models are used, it becomes feasible to generate description data that can express the type of time-sequential data constituting the moving image data. In this case, using the time-sequential data transition models (e.g., HMM data) described in the present exemplary embodiment is useful in that the models are robust against nonlinear expansion/compression in the time direction of each time-sequential data. As a result, it becomes feasible to eliminate adverse influences that may be caused by the nonlinear expansion/compression in the time direction of the moving image data.

Further, it is feasible to describe details of each moving image data because numerous time-sequential data are extracted from the moving image data and the moving image data are described based on the extracted numerous time-sequential data. Using the above-mentioned description data is useful to eliminate adverse influences of the nonlinear expansion/compression in the time direction. It becomes feasible to perform moving image pattern identification on complicated moving image data. In the present exemplary embodiment, determining whether the input moving image data belongs to the predetermined category C is an example of the 2-class identification. However, the present invention is not limited to the above-mentioned example. For example, it is useful to prepare moving image pattern models for each of a plurality of categories and identify the category of the input moving image data in such a way as to realize a multi-class identification.

A second exemplary embodiment according to the present invention provides a modified example of the moving image pattern identification method using the moving image information processing method described in the first exemplary embodiment. More specifically, similar to the first exemplary embodiment, the second exemplary embodiment according to the present invention provides an example of the moving image pattern identification method that can determine whether the input moving image data belongs to the predetermined category C. The format of input moving image data used in the present exemplary embodiment is similar to that of the moving image data described in the first exemplary embodiment. The method includes determining whether the content of the moving image data is a specific sports scene. The present exemplary embodiment includes a portion similar to that described in the first exemplary embodiment and therefore redundant description thereof will be avoided.

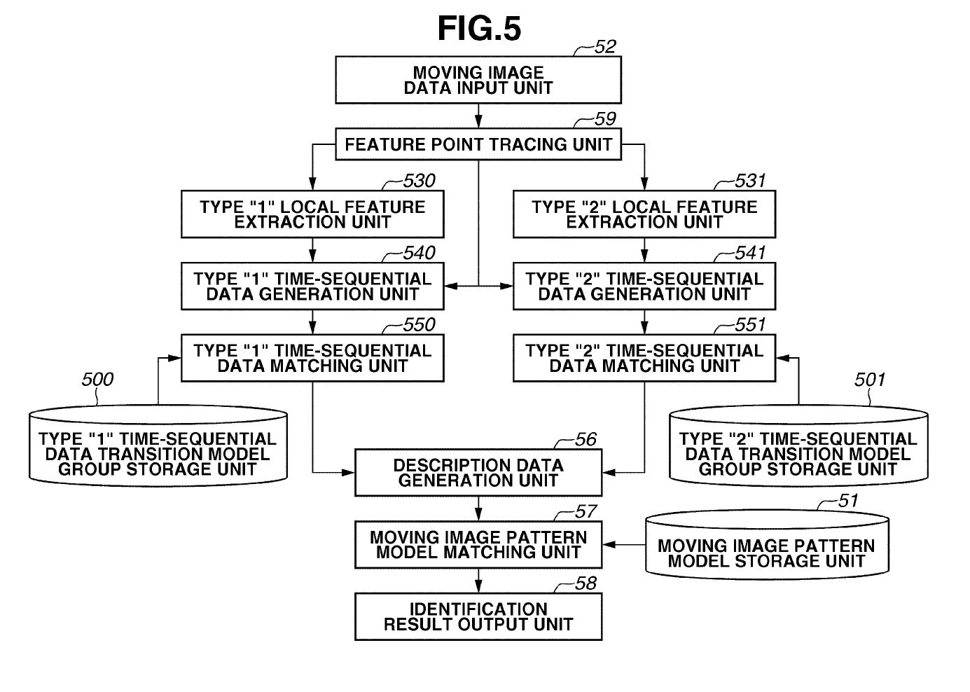

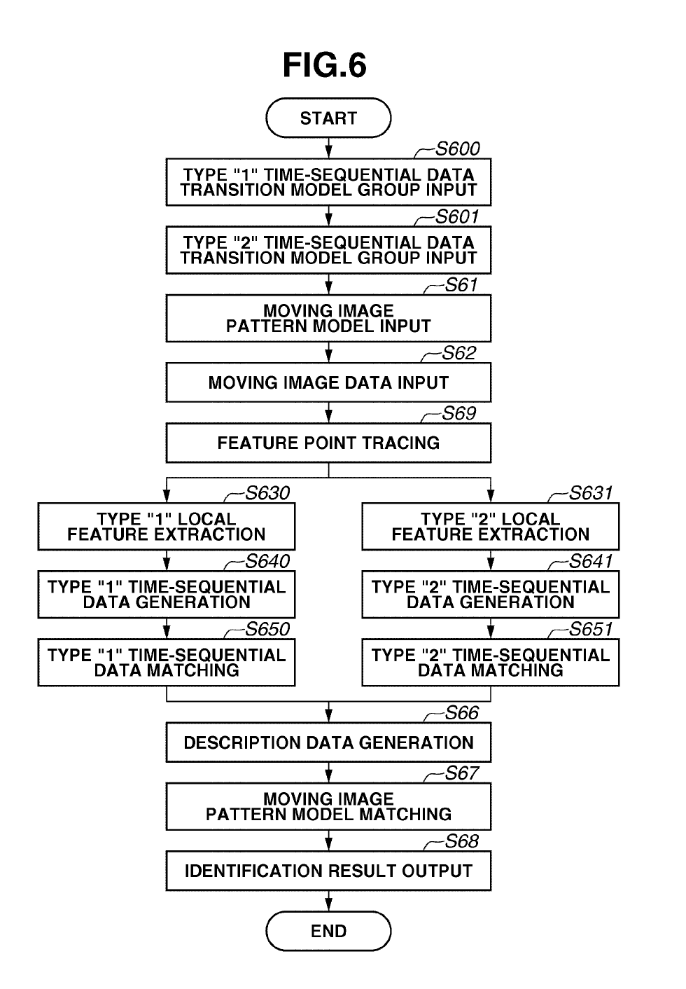

FIG. 5 is a diagram illustrating example processing blocks of the moving image pattern identification method according to the present exemplary embodiment. FIG. 6 is a flowchart illustrating example processing of the moving image pattern identification method according to the present exemplary embodiment. An example of the moving image pattern identification method according to the present exemplary embodiment is described in detail below with reference to FIGS. 5 and 6.

A type “1” time-sequential data transition model group storage unit 500 and a type “2” time-sequential data transition model group storage unit 501 are data storage units configured to store a plurality of time-sequential data transition models, similar to the time-sequential data transition model group storage unit 10 described in the first exemplary embodiment.

The time-sequential data transition models stored in the type “1” time-sequential data transition model group storage unit 500 are different from the time-sequential data transition models stored in the type “2” time-sequential data transition model group storage unit 501. In the present exemplary embodiment, the type “1” time-sequential data transition model group storage unit 500 stores numerous time-sequential data transition models (i.e., HMM data) similar to those described in the first exemplary embodiment. The data input in the present exemplary embodiment are 400 pieces of HMM data. An index is allocated to each HMM and stored in the type “1” time-sequential data transition model group storage unit 500. The processing to be performed by type “1” time-sequential data transition model group storage unit 500 corresponds to a type “1” time-sequential data transition model group input step S600 illustrated in FIG. 6.

On the other hand, the type “2” time-sequential data transition model group storage unit 501 stores numerous DP matching models as time-sequential data transition models. A plurality of models generated beforehand can be input as type “2” time-sequential data transition models and stored in the type “2” time-sequential data transition model group storage unit 501. The processing to be performed by the type “2” time-sequential data transition model group storage unit 501 corresponds to a type “2” time-sequential data transition model group input step S601 illustrated in illustrated in FIG. 6.

At least one piece of model data, which can serve as the type “2” time-sequential data transition model, is input. In the present exemplary embodiment, 100 DP matching models are input. Similar to the HMM data, a plurality of models generated beforehand can be input as type “2” time-sequential data transition models, i.e., DP matching models. An example generation method is described in detail below.

A moving image pattern model storage unit 51 is a data storage unit configured to store moving image pattern models that belong to a predetermined category, similar to the moving image pattern model storage unit 11 described in the first exemplary embodiment.

In the present exemplary embodiment, an example method for determining whether the input moving image data belongs to the predetermined category C is the SVM. Therefore, in the present exemplary embodiment, the moving image pattern model storage unit 51 receives and stores the moving image data that belong to the predetermined category C and moving image pattern identification model data generated using moving image data that belongs to a category other than the category C. The processing to be performed by the moving image pattern model storage unit 51 corresponds to a moving image pattern model input step S61 illustrated in FIG. 6. The moving image pattern identification model data input in this case and an example method for generating the moving image pattern identification model data is described in detail below.

A moving image data input unit 52 is a processing unit configured to receive moving image data of an identification target to check whether the target belongs to the predetermined category C, similar to the moving image data input unit 12 described in the first exemplary embodiment. The format of the moving image data used in the second exemplary embodiment is similar to that described in the first exemplary embodiment. More specifically, the moving image data has an image size of 320×240 pixels and includes 60 frames in total. The processing to be performed in the moving image data input unit 52 corresponds to a moving image data input step S62 illustrated in illustrated in FIG. 6.

A feature point tracing unit 59 is a processing unit configured to obtain a plurality of feature point tracing results, for example, by tracing feature points (e.g., angular points) on the moving image data input via the moving image data input unit 52. The processing to be performed by the feature point tracing unit 59 corresponds to a feature point tracing step S69 illustrated in FIG. 6. An example feature point tracing method used in the present exemplary embodiment is the KLT method, which can obtain numerous feature point tracing results from the input moving image data. For example, the KLT method is described in non-patent literature document entitled “Detection and Tracking of Point Features”, by C. Tomasi and T. Kanade, Carnegie Mellon University Technical Report CMU-CS-91-132, 1991.

Although the feature point tracing method used in the present exemplary embodiment is the KLT method, the present invention is not limited to the above-mentioned example. For example, a conventional feature point tracing method that uses SIFT feature quantities is discussed in non-patent literature document entitled “Hierarchical Spatio-Temporal Context Modeling for Action Recognition”, by Ju Sun, Xiao Wu, Shuicheng Yan, Loong-Fah Cheong, Tat-Seng Chua and Jintao Li, IEEE Computer Society Conference on Computer Vision and Pattern Recognition, pp. 2004-2011, 2009. Any other method capable of tracing a point on an image in response to a temporal change of the image is usable.

A type “1” local feature extraction unit 530 is configured to extract local features from each frame image, similar to the local feature extraction unit 13 described in the first exemplary embodiment. However, the type “1” local feature extraction unit 530 extracts local features in a region having the center positioned at each feature point obtained by the feature point tracing unit 59. In this respect, the type “1” local feature extraction unit 530 is different from the local feature extraction unit 13 that extracts local features at the fixed point determined beforehand. More specifically, the type “1” local feature extraction unit 530 extracts local features in a region having the center positioned at the feature point of each frame in a plurality of feature point tracing results obtained by the feature point tracing unit 59. The processing to be performed by the type “1” local feature extraction unit 530 corresponds to a type “1” local feature extraction step S630 illustrated in FIG. 6.

The local features to be extracted in the present exemplary embodiment are the HOG features, similar to the first exemplary embodiment. Therefore, the type “1” local feature extraction unit 530 extracts HOG features from a local area of 27×27 pixels having the center positioned at each feature point.

A type “1” time-sequential data generation unit 540 is configured to generate a plurality of pieces of type “1” time-sequential data based on the feature point tracing results obtained by the feature point tracing unit 59 and the local features extracted by the type “1” local feature extraction unit 530. In the present exemplary embodiment, the type “1” time-sequential data generation unit 540 generates one piece of time-sequential data for each feature point tracing result obtained by the feature point tracing unit 59. The processing to be performed by the type “1” time-sequential data generation unit 540 corresponds to a type “1” time-sequential data generation step S640 illustrated in FIG. 6.

In the present exemplary embodiment, the type “1” time-sequential data generation unit 540 obtains differences in the HOG features between two temporally neighboring feature points in the same feature point tracing result, and sets a time-sequentially array of the obtained differences as one piece of time-sequential data.

For example, it is now presumed that one feature point tracing result includes a tracing of feature points in 40 frames of all frames (i.e., 60 frames). Further, it is presumed that respective feature points of an image are positioned at (u₁, v₁), (u₂, v₂), . . . , and (u₄₀, v₄₀) and the HOG features at respective feature point positions are h₁, h₂, . . . , and h₄₀. In this case, the time-sequential data that corresponds to the above-mentioned feature point tracing result is an array of 39 HOG features differences (i.e., h₂−h₁, h₃−h₂, . . . , and h₄₀−h₃₉).

A type “2” local feature extraction unit 531 is configured to perform processing for obtaining local displacement features (hereinafter, simply referred to as “displacement features”) for each feature point included in the feature point tracing results obtained by the feature point tracing unit 59. The displacement features indicate a displacement of each feature point position relative to the feature point position in a temporally neighboring precedent frame. The processing to be performed by the type “2” local feature extraction unit 531 corresponds to a type “2” local feature extraction step S631 illustrated in FIG. 6.

According to the displacement features in the present exemplary embodiment, a variation amount of the feature point position is quantized into any one of five patterns, i.e., upward displacement (U), downward displacement (D), leftward displacement (L), rightward displacement (R), and no displacement (O).

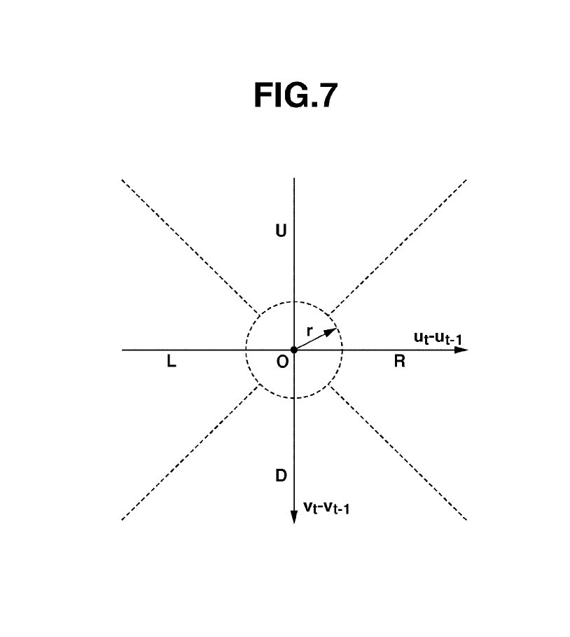

For example, it is now presumed that a feature point position is (uₜ, vₜ) and the feature point position in the precedent frame is (uₜ₋₁, vₜ₋₁) in a feature point tracing result that includes the feature point. In this case, the variation amount is (uₜ−uₜ₋₁, vₜ−vₜ₋₁). The above-mentioned quantization using five patterns is performed based on the variation amount with reference to a standard map illustrated in FIG. 7.

More specifically, in the present exemplary embodiment, if L2 norm=((uₜ−uₜ₋₁)2+(vₜ−vₜ₋₁)2)½ of the variation amount is equal to or less than a predetermined threshold value r (i.e., the inside of a dotted circular line illustrated in FIG. 7), the type “2” local feature extraction unit 531 regards the variation amount as no displacement and quantizes it into the pattern “O.” Further, in a case where the L2 norm is equal to or greater than the predetermined threshold value r (i.e., the outside of the dotted circular line illustrated in FIG. 7) and the condition |uₜ−uₜ₋₁|<|vₜ−vₜ₋₁| is satisfied, the type “2” local feature extraction unit 531 quantizes the variation amount into the parameter “R” if uₜ−uₜ₋₁>0 and the parameter “L” if uₜ−uₜ₋₁<0 as illustrated in FIG. 7. On the other hand, in a case where the condition |uₜ−uₜ₋₁|<|vₜ−vₜ₋₁| is satisfied, the type “2” local feature extraction unit 531 quantizes the variation amount into the parameter “D” if vₜ−vₜ₋₁>0 and “U” if vₜ₋ₜ₋₁<0. Note that, in this example, that since the vertical lower direction is set as the v positive direction, the direction of vₜ−vₜ₋₁ is downward.

Further, in the present exemplary embodiment, the starting point of the feature point tracing result is constantly set to the point “O” that indicates no displacement. The predetermined threshold value r can be changed to an appropriate value depending on the image size so that a feature point remaining in the area defined by the threshold value r can be regarded as being stationary. The threshold value r used in the present exemplary embodiment is equivalent to three pixels. Determining the displacement features at each feature point using the above-mentioned standard map is useful in that the displacement features at each feature point can be simply classified into any one of the above-mentioned five patterns “U”, “D”, “L”, “R”, and “O.”

A type “2” time-sequential data generation unit 541 is configured to generate a plurality of pieces of type “2” time-sequential data based on the feature point tracing results obtained by the feature point tracing unit 59 and the displacement features obtained by the type “2” local feature extraction unit 531. The type “2” time-sequential data generation unit 541 generates one piece of time-sequential data for each feature point tracing result obtained by the feature point tracing unit 59, similar to the type “1” time-sequential data generation unit 540. The processing to be performed by the type “2” time-sequential data generation unit 541 corresponds to a type “2” time-sequential data generation step S641 illustrated in FIG. 6. In the present exemplary embodiment, the type “2” time-sequential data generation unit 541 sets a time-sequentially disposed array of displacement features that correspond to respective feature points in the same feature point tracing result as one piece of time-sequential data.

For example, similar to the example of the type “1” time-sequential data generation unit 540, it is now presumed that one feature point tracing result includes a tracing of feature points in 40 frames of all frames (i.e., 60 frames). Further, it is presumed that the displacement features at respective feature points, which can be obtained by the above-mentioned displacement feature extraction unit 531, are d₁=“O”, d₂=“R”, . . . , and d₄₀=“U.” In this case, the time-sequential data corresponding to the feature point tracing result is a time-sequentially disposed array of these 40 displacement features.

A type “1” time-sequential data matching unit 550 is a processing unit that is substantially similar to the time-sequential data matching unit 15 described in the first exemplary embodiment, although the processing content is slightly different. First, the type “1” time-sequential data matching unit 550 performs matching of each of the numerous type “1” time-sequential data generated by the type “1” time-sequential data generation unit 540 and the plurality of type “1” time-sequential data transition models stored in the type “1” time-sequential data transition model group storage unit 500. The processing performed by the type “1” time-sequential data matching unit 550 in this case is similar to the processing performed by the time-sequential data matching unit 15 described in the first exemplary embodiment.

Subsequently, the type “1” time-sequential data matching unit 550 performs processing for obtaining a conformity degree of each type “1” time-sequential data in relation to each type “1” time-sequential data transition model. The conformity degree obtained in this case is a value indicating how a time-sequential data matches a time-sequential data transition model. In the present exemplary embodiment, the conformity degree is a probability that the type “1” time-sequential data matches the type “1” time-sequential data transition model.

As mentioned above, the most closely matched time-sequential data transition model for each time-sequential data is obtained in the first exemplary embodiment. On the other hand, in the present exemplary embodiment, the type “1” time-sequential data matching unit 550 obtains the conformity degree that indicates the probability that a time-sequential data matches a time-sequential data transition model. The processing to be performed by type “1” time-sequential data matching unit 550 corresponds to a type “1” time-sequential data matching step S650 illustrated in illustrated in FIG. 6. In the present exemplary embodiment, the probability p(i|X) of a type “1” time-sequential data X matching the i-th type “1” time-sequential data transition model can be obtained using the following formula.

$$p ( i \vert X ) = \frac{p ( X \vert i ) p ( i )}{{Σ}_{j} p ( X \vert j ) p ( j )} \qquad [ formula 1 ]$$

In the formula 1, p(X|i) represents a likelihood of the time-sequential data X in the i-th type “1” time-sequential data transition model, and p(i) represents a prior probability that an arbitrary time-sequential data is the i-th type “1” time-sequential data transition model. In the denominator, Σj indicates the sum total for all type “1” time-sequential data transition models. The prior probability can be a constant value for all type “1” time-sequential data transition models. Alternatively, it is useful to obtain a prior probability at the generation timing of the type “1” time-sequential data transition models. The type “1” time-sequential data transition models to be used in this case are similar to the time-sequential data transition models described in the first exemplary embodiment.

However, the data used in the first exemplary embodiment are time-sequential data of local features at a fixed point. On the other hand, the data used in the present exemplary embodiment are time-sequential data of local features at a traced feature point. Therefore, it is desired to generate the type “1” time-sequential data transition models using a method slightly different from the time-sequential data transition model generation method described in the first exemplary embodiment with reference to FIGS. 3 and 4.

More specifically, the slightly modified method includes generating numerous type “1” time-sequential data from a plurality of pieces of moving image data through the above-mentioned processing performed by the feature point tracing unit 59, the type “1” local feature extraction unit 530, and the type “1” time-sequential data generation unit 540 illustrated in FIG. 5. The method further includes cumulatively storing the generated type “1” time-sequential data in the time-sequential data group storage unit 35 illustrated in FIG. 3. Then, time-sequential data transition models can be generated using a method similar to that described in the first exemplary embodiment. The prior probability of each type “1” time-sequential data transition model can be determined based on the number of the type “1” time-sequential data allocated to each type “1” time-sequential data transition model at the time when it is determined that the generation processing has been converged.

More specifically, the method includes obtaining p(i)=(the number of type “1” time-sequential data allocated to the i-th type “1” time-sequential data transition model)/(the number of all type “1” time-sequential data used in the generation). As mentioned above, the present exemplary embodiment is different from the first exemplary embodiment in that the processing method includes obtaining a conformity degree that indicates a probability that a processing target time-sequential data matches each time-sequential data transition model, instead of identifying only one closely matched time-sequential data transition model.

As mentioned above, the models used in the present exemplary embodiment are 400 type “1” time-sequential data transition models. Therefore, the total number of conformity degrees obtained for only one type “1” time-sequential data is 400 because one conformity degree is obtained in relation to each of 400 type “1” time-sequential data transition models.

A type “2” time-sequential data matching unit 551 is a processing unit configured to perform matching of the type “2” time-sequential data generated by the type “2” time-sequential data generation unit 541 and the type “2” time-sequential data transition models stored in the type “2” time-sequential data transition model group storage unit 501.

The type “2” time-sequential data matching unit 551 is different from the type “1” time-sequential data matching unit 550 in obtaining a type “2” time-sequential data transition model that most closely matches each type “2” time-sequential data, similar to the time-sequential data matching unit 15 described in the first exemplary embodiment.

As mentioned above, the type “2” time-sequential data transition models used in the present exemplary embodiment are DP matching models. Although described in detail below, each DP matching model has a data format similar to that of the type “2” time-sequential data generated by the type “2” time-sequential data generation unit 541. More specifically, the DP matching model is an array of a plurality of displacement features, each being classified into any one of the above-mentioned five patterns “U”, “D”, “L”, “R”, and “O.”

Accordingly, the matching processing to be performed by the type “2” time-sequential data matching unit 551 includes simply performing DP matching of symbol trains. Accordingly, the type “2” time-sequential data matching unit 551 can perform the inter-symbol train DP matching of each type “2” time-sequential data and respective DP matching models, and can identify a matched type “2” time-sequential data transition model having the lowest matching cost. A constant matching cost can be set for the DP matching of different symbols. Alternatively, a higher matching cost can be set for opposed symbols (e.g., “U” and “D”, or “L” and “R”).

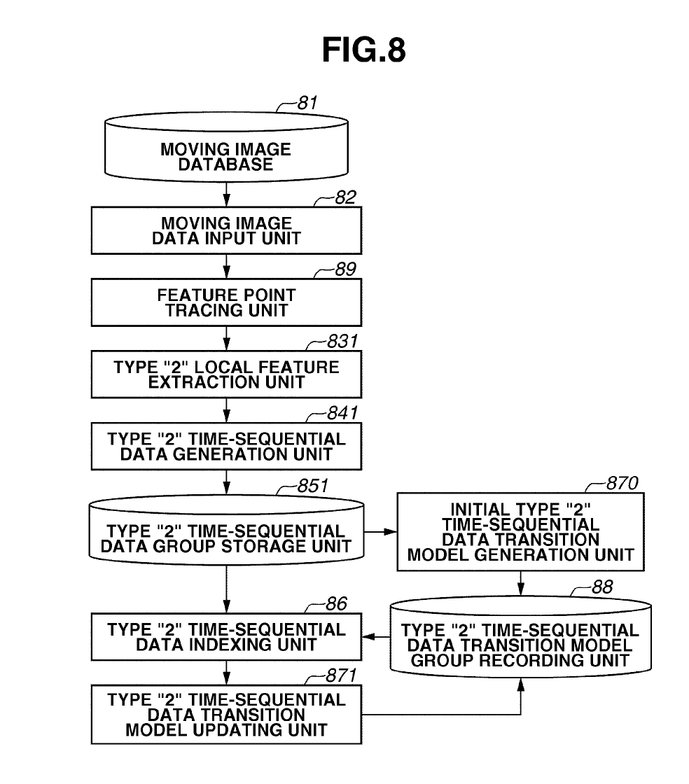

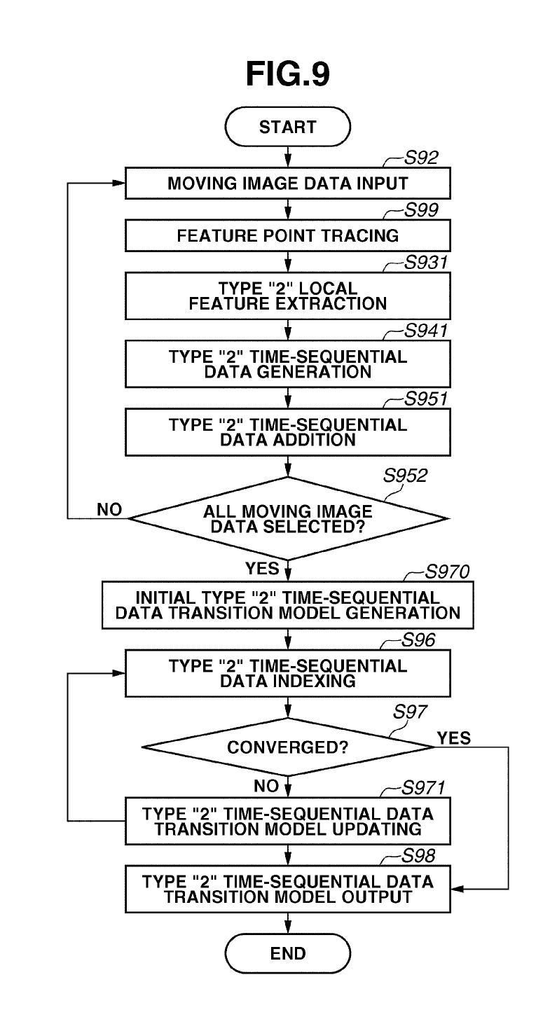

An example method for generating a plurality of type “2” time-sequential data transition models is described below with reference to a processing block diagram of a type “2” time-sequential data transition model generation method illustrated in FIG. 8 and a processing flowchart of the type “2” time-sequential data transition model generation method illustrated in FIG. 9. The type “2” time-sequential data transition model generation method according to the present exemplary embodiment is substantially similar to the time-sequential data transition model generation method described in the first exemplary embodiment with reference to FIGS. 3 and 4. Therefore, redundant description of similar portions will be avoided.

A moving image database 81 and a moving image data input unit 82 are similar to the moving image database 31 and the moving image data input unit 32 illustrated in FIG. 3. The moving image data input unit 82 successively receives numerous moving image data from the moving image database 81. The processing to be performed by the moving image database 81 and the moving image data input unit 82 correspond to a moving image data input step S92 illustrated in FIG. 9.

A feature point tracing unit 89, a type “2” local feature extraction unit 831, and a type “2” time-sequential data generation unit 841 are processing units that are similar to the feature point tracing unit 59, the type “2” local feature extraction unit 531, and the type “2” time-sequential data generation unit 541 described in the present exemplary embodiment with reference to FIG. 5. Processing to be performed in each processing unit is similar to the above-mentioned processing and therefore redundant description thereof will be avoided. Through the processing performed by each processing unit, numerous type “2” time-sequential data can be extracted from the moving image data input via the moving image data input unit 82 and can be cumulatively stored in a type “2” time-sequential data group storage unit 851. The processing to be performed by the feature point tracing unit 89, the type “2” local feature extraction unit 831, and the type “2” time-sequential data generation unit 841 corresponds to a feature point tracing step 99, a type “2” local feature extraction step S931, a type “2” time-sequential data generation step S941, and a type “2” time-sequential data addition step S951 illustrated in FIG. 9.

When the above-mentioned processing has been completed for all moving image data stored in the moving image database 81 (Yes in step S952), numerous type “2” time-sequential data can be stored in the type “2” time-sequential data group storage unit 851.

After numerous type “2” time-sequential data are extracted from numerous moving image data and recorded through the above-mentioned processing, actual type “2” time-sequential data transition model generation processing can be performed based on these data. In the present exemplary embodiment, the type “2” time-sequential data transition model generation processing is performed according to a K-medoids based clustering method, which is discussed in non-patent literature document entitled “Integer Programming and Theory of Grouping”, by H. Vinod, Journal of American Statistical Association, Vol. 64, pp. 506-517, 1969, which uses matching costs of the DP matching applied to the distance between data.

The above-mentioned generation processing is described in detail below.

An initial type “2” time-sequential data transition model generation unit 870 is a processing unit configured to generate initial type “2” time-sequential data transition models. First, the initial type “2” time-sequential data transition model generation unit 870 randomly samples some of the type “2” time-sequential data stored in the type “2” time-sequential data group storage unit 851. The number of the type “2” time-sequential data to be sampled in this case is equal to the number of type “2” time-sequential data transition models to be generated. As mentioned above, the number of the type “2” time-sequential data transition models used in the present exemplary embodiment is 100. Therefore, the initial type “2” time-sequential data transition model generation unit 870 randomly samples 100 pieces of type “2” time-sequential data. Further, the initial type “2” time-sequential data transition model generation unit 870 sets the sampled type “2” time-sequential data as the initial type “2” time-sequential data transition models.

More specifically, an index is allocated to each of the sampled type “2” time-sequential data, although the order can be arbitrarily determined. The indexed type “2” time-sequential data are recorded, as the initial type “2” time-sequential data transition models, in a type “2” time-sequential data transition model group recording unit 88. In the present exemplary embodiment, the total number of the type “2” time-sequential data transition models is 100. Therefore, index numbers 1 to 100 are sequentially allocated to the type “2” time-sequential data transition models. The processing to be performed by the initial type “2” time-sequential data transition model generation unit 870 corresponds to an initial type “2” time-sequential data transition model generation step S970 illustrated in FIG. 9.

A type “2” time-sequential data indexing unit 86 is configured to perform processing for allocating the index of the type “2” time-sequential data transition model to each of the numerous type “2” time-sequential data stored in the type “2” time-sequential data group storage unit 851. The processing to be performed by the type “2” time-sequential data indexing unit 86 is similar to the processing performed by the time-sequential data indexing unit 361, which is described in the first exemplary embodiment with reference to FIG. 3, although the matching processing of the time-sequential data performed by the type “2” time-sequential data indexing unit 86 is the DP matching processing. In the present exemplary embodiment, similar to the processing performed by the type “2” time-sequential data matching unit 551 illustrated in FIG. 5, the type “2” time-sequential data indexing unit 86 performs DP matching of each type “2” time-sequential data and all type “2” time-sequential data transition models recorded in the type “2” time-sequential data transition model group recording unit 88.

Then, the type “2” time-sequential data indexing unit 86 allocates an index that corresponds to a type “2” time-sequential data transition model having the lowest matching cost to each type “2” time-sequential data. The processing to be performed by the type “2” time-sequential data indexing unit 86 corresponds to a type “2” time-sequential data indexing step S96 illustrated in FIG. 9.

Through the processing performed by the type “2” time-sequential data indexing unit 86, a unique index is allocated to each type “2” time-sequential data. At this moment, in step S97, it is determined whether the generation processing has been converged, similar to the generation of time-sequential data transition models in the first exemplary embodiment.

More specifically, similar to the processing described in the first exemplary embodiment, if the newly allocated index coincides with the previously allocated index, it is determined that the generation processing has been converged. If the newly allocated index does not coincide with the previously allocated index, it is determined that the generation processing is not yet converged.

When the generation processing is not yet converged, the operation proceeds to processing to be performed by a type “2” time-sequential data transition model updating unit 871. The type “2” time-sequential data transition model updating unit 871 repetitively performs the processing in the type “2” time-sequential data indexing unit 86 and the type “2” time-sequential data transition model updating unit 871 until it is determined that the generation processing has been converged.

The type “2” time-sequential data transition model updating unit 871 updates the type “2” time-sequential data transition model that corresponds to each index, using an assembly of type “2” time-sequential data that have the same index allocated by the type “2” time-sequential data indexing unit 86. In the present exemplary embodiment, similar to the first exemplary embodiment, the type “2” time-sequential data transition model updating unit 871 determines type “2” time-sequential data transition models to simulate the plurality of pieces of type “2” time-sequential data having the same index.

Then, the type “2” time-sequential data transition model updating unit 871 updates the type “2” time-sequential data transition models of each index, which are recorded in the type “2” time-sequential data transition model group recording unit 88, by the determined type “2” time-sequential data transition models. The processing to be performed by the type “2” time-sequential data transition model updating unit 871 corresponds to a type “2” time-sequential data transition model updating step S971 illustrated in FIG. 9. In the present exemplary embodiment, the type “2” time-sequential data transition model updating unit 871 selects a data that represents a plurality of pieces of type “2” time-sequential data having the same index and designates the selected data itself as a type “2” time-sequential data transition model that simulates these data.

More specifically, the type “2” time-sequential data transition model updating unit 871 performs DP matching of every two type “2” time-sequential data that are combinable in the assembly of type “2” time-sequential data having the same index and obtains matching costs of respective combinations.

More specifically, the type “2” time-sequential data transition model updating unit 871 extracts two type “2” time-sequential data from the assembly of type “2” time-sequential data having the same index and regards one of them as a DP matching model, and calculates a matching cost in relation to the other data. The type “2” time-sequential data transition model updating unit 871 repetitively performs the above-mentioned calculation processing on every combination of two type “2” time-sequential data included in the assembly of type “2” time-sequential data having the same index.

Then, the type “2” time-sequential data transition model updating unit 871 obtains the sum total of matching costs in the combinations of each of the type “2” time-sequential data and other type “2” time-sequential data having the same index. Finally, the type “2” time-sequential data transition model updating unit 871 selects a piece of type “2” time-sequential data whose sum total is minimum in the assembly of type “2” time-sequential data having the same index, as a piece of representative data of the assembly, and designates the selected type “2” time-sequential data itself as a new piece of type “2” time-sequential data of the corresponding index.

As mentioned above, selecting a piece of specific data that can minimize the sum total of matching costs is schematically feasible to select a data that is positioned at the center of a data assembly. The selected central data is regarded as a representative data of the data assembly and designated as a corresponding type “2” time-sequential data transition model.

After the type “2” time-sequential data indexing unit 86 has completed the above-mentioned processing, if it is determined that the generation processing has converged, the type “2” time-sequential data transition model updating unit 871 outputs the plurality of type “2” time-sequential data transition models recorded in the type “2” time-sequential data transition model recording unit 88, as a final result. The processing to be performed by the type “2” time-sequential data transition model updating unit 871 corresponds to a type “2” time-sequential data transition model output step S98 illustrated in FIG. 9. The entire processing of the type “2” time-sequential data transition model generation method terminates upon completing the output of the final type “2” time-sequential data transition models. The above-mentioned processing can generate a plurality of type “2” time-sequential data transition models according to the present exemplary embodiment.

The type “2” time-sequential data transition models are stored in the type “2” time-sequential data transition model group storage unit 501 illustrated in FIG. 5. The type “2” time-sequential data matching unit 551 illustrated in FIG. 5 performs processing with reference to the stored type “2” time-sequential data transition models.

Referring back to the moving image pattern identification method according to the present exemplary embodiment, a description data generation unit 56 illustrated in FIG. 5 is configured to perform processing for generating description data of the moving image data based on the processing results obtained by the type “1” time-sequential data matching unit 550 and the type “2” time-sequential data matching unit 551. In the present exemplary embodiment, the description data generation unit 56 generates description data relating to the type “1” time-sequential data and description data relating to the type “2” time-sequential data, which are simply connected as an integrated description data. The processing to be performed by the description data generation unit 56 corresponds to a description data generation step S66 illustrated in illustrated in FIG. 6.

Similar to the first exemplary embodiment, when the type “2” time-sequential data is received, the description data generation unit 56 obtains the number of the most closely matched type “2” time-sequential data for each type “2” time-sequential data transition model and generates frequency data that is an array of the obtained numerical values. The total number of type “2” time-sequential data transition models used in the present exemplary embodiment is 100. Therefore, the frequency data generated in this case is an array of 100 numerical values.

On the other hand, when the type “1” time-sequential data is received, the description data generation unit 56 generates cumulative conformity data by accumulating conformity degrees of respective type “1” time-sequential data for each type “1” time-sequential data transition model.

More specifically, it is now presumed that the sum total of conformity degrees is 12.5 in the first type “1” time-sequential data transition model, 3.2 in the second type “1” time-sequential data transition model, 7.8 in the third, . . . , according to the result of all type “1” time-sequential data. In this case, the cumulative conformity data generated in this case is an array of numerical values 12.5, 3.2, 7.8, . . . , i.e., an array of cumulative conformity values that corresponds to the number of all type “1” time-sequential data transition models. As mentioned above, the total number of type “1” time-sequential data transition models used in the present exemplary embodiment is 400. Therefore, the cumulative conformity data generated in this case is an array of 400 numerical values.

Then, the description data generation unit 56 simply connects the obtained cumulative conformity data to the above-mentioned frequency data generated for the above-mentioned type “2” time-sequential data to obtain the description data of the moving image data in the present exemplary embodiment. As mentioned above, the cumulative conformity data obtained in the present exemplary embodiment is the array of 400 numerical values. Further, the frequency data generated for the type “2” time-sequential data is the array of 100 numerical values. Therefore, the description data to be generated by the description data generation unit 56 is an array of 500 numerical values.

A moving image pattern model matching unit 57 is configured to perform matching of the description data generated by the description data generation unit 56 and the moving image pattern models stored in the moving image pattern model storage unit 51. The processing to be performed by the moving image pattern model matching unit 57 corresponds to a moving image pattern model matching step S67 illustrated in illustrated in FIG. 6. In the present exemplary embodiment, the moving image pattern model matching unit 57 performs pattern identification processing using the SVM, in which normalization of the description data generated by the description data generation unit 56 is first performed.

The normalization to be applied to the description data in this case includes normalizing a cumulative conformity data portion generated with respect to the type “1” time-sequential data and normalizing a frequency data portion generated with respect to the type “2” time-sequential data, which are performed independently in such a way as to equalize the sum total of respective values to 1. Then, the moving image pattern model matching unit 57 regards the normalized data as a multi-dimensional vector and determines whether it is moving image data that belongs to the predetermined category C based on the moving image pattern models, i.e., SVM identification model data.

The SVM identification model data used in the present exemplary embodiment and an example generation method thereof are described in detail below. The SVM identification model used in the present exemplary embodiment is a 2-class SVM identification model whose kernel function k(x, x′) is a chi-square kernel defined by the following formula 2.

$$k ( x , {x}^{′} ) = exp \{ - \frac{1}{2 S} \sum \frac{{( {x}_{1} - {x}_{1}^{′} )}^{2}}{{x}_{1} + {x}_{1}^{′}} \} \qquad [ formula 2 ]$$

In the formula 2, x represents a vector and xᵢ represents an i-th element of the vector x. Further, Σ indicates the sum total of all elements of the vector, and S is a parameter that determines a kernel width. In general, an expected value of the chi-square distance between two data can be used as the parameter S that determines the kernel width. The SVM identification model can be expressed using the following formula, which includes the kernel function k.

$${Σ}_{SV} {α}_{{SV}_{j}} \cdot k ( x , {x}_{( {SV}_{j} )} ) + β \{ \begin{matrix}\geq 0 … Positive \\ < 0 … Negative\end{matrix} \qquad [ formula 3 ]$$

In the formula 3, x_{(SVj)} represents the j-th support vector, α_{SVj} represents a coupling coefficient corresponding to the j-th support vector, and β is a bias item. Further, Σ_{SV} indicates the sum total of all support vectors. When a vector x is input, the left side of the formula 3 is calculated. If the calculated value is equal to or greater than 0 (i.e., positive), it is determined that the vector belongs to the predetermined category C. If the calculated value is less than 0 (i.e., negative), it is determined that the vector does not belong to the predetermined category C. In the present exemplary embodiment, the moving image pattern model matching unit 57 regards the normalized description data as the multi-dimensional vector x and calculates the left side of the formula 3. Then, the moving image pattern model matching unit 57 determines whether the vector x belongs to the predetermined category C based on the calculated value (positive or negative).

Accordingly, the SVM identification model can be expressed using a plurality of support vectors {x_{(SVj)}}, coupling coefficients α_{SVj} corresponding to respective vectors, the bias item β, and the parameter S that determines the kernel width. The SVM identification model data can be generated beforehand using numerous moving image data that belong to the predetermined category C and numerous moving image data that do not belong to the predetermined category C, according to the following method.

The method includes generating description data of each moving image data and normalizing the generated description data using the above-mentioned method by causing the moving image data input unit 52 to the description data generation unit 56 to perform the above-mentioned sequential processing according to the present exemplary embodiment on each of numerous moving image data. For example, if the total number of the moving image data that belong to the category C and the moving image data that do not belong to the category C is N pieces in total, the number of normalized data that can be obtained through the above-mentioned processing is N pieces. The obtained normalized data can be regarded as N multi-dimensional vectors x₍ᵢ₎ {j=1, 2, . . . , N}. The method further includes obtaining the parameter S that determines the kernel width, using the N multi-dimensional vectors, according to the following formula.

$$S = \frac{1}{N ( N - 1 )} {\sum }_{j = 1}^{N} {\sum }_{k = j + 1}^{N} ( \sum \frac{{( {x}_{( j ) i} - {x}_{( k ) i} )}^{2}}{( {x}_{( j ) i} + {x}_{( k ) i} )} ) \qquad [ formula 4 ]$$

The obtained parameter S is an expected value of the chi-square distance between two data, which is estimated using the above-mentioned N pieces of multi-dimensional vector data. The method further includes obtaining a coefficient αⱼ {j=1, 2, . . . , N} for each vector, using the obtained S value, as a solution of an optimization problem including the following constraint.

$${max}_{α} {\sum }_{j = 1}^{N} {α}_{j} - \frac{1}{2} {\sum }_{j = 1}^{N} {\sum }_{k = 1}^{N} {α}_{j} {α}_{k} {y}_{j} {y}_{k} k ( {x}_{( j )} , {x}_{( k )} ) \\ subject to \{ \begin{matrix}0 \leq {α}_{j} \leq C \\ {\sum }_{j = 1}^{N} {α}_{j} {y}_{j} = 0\end{matrix} \qquad [ formula 5 ]$$

In the formula 5, yⱼ is label information corresponding to the vector x₍ⱼ₎. In the present exemplary embodiment, the label information is 1 (i.e., yⱼ=1) if the vector x₍ⱼ₎ is originated from the moving image data that belong to the predetermined category C and is −1 (i.e., yⱼ=−1) if not originated. Further, C included in the constraint condition is a ft margin parameter of the SVM. The ft margin parameter can be optimized, for example, using a cross-validation (e.g., 5-Fold Cross-Validation). As the result of the optimization problem of the formula 5, a generally sparse solution (more specifically, a solution including numerous 0 values) can be obtained for αⱼ{j=1, 2, . . . , N}. Then, all vectors that do not correspond to non-0 solutions become support vectors. For example, if the result of the above-mentioned optimization problem is α₁=0, α₂=1, . . . , the vector x₍₁₎ that corresponds to α₁ does not become a support vector and the vector x₍₂₎ that corresponds to α₂ become a support vector, . . . .

In this case, for example, it is presumed that the coupling coefficient corresponding to support vector x₍₂₎ is y₂α₂. More specifically, if αⱼ≠0, then x₍ⱼ₎ becomes a support vector and its coupling coefficient becomes yⱼαⱼ. Finally, the bias item β can be obtained by using an arbitrary support vector x_{(SVa)}, which is included in the obtained support vectors and is smaller than C in the absolute value of the coupling coefficient, and label information corresponding to y_{SVa}, according to the following formula.

β=y_{SV}_{ₐ}−Σ_{SV}α_{SV}_{ⱼ}·k(x_{(SV}_{ₐ}₎,x_{(SV}_{ⱼ}₎) [formula 6]

The parameter S that determines the kernel width, a plurality of support vectors, corresponding coupling coefficients, and the bias item β can be obtained according to the above-mentioned method, as the SVM identification model data according to the present exemplary embodiment. Then, as mentioned above, the generated SVM identification model data is stored in the moving image pattern model storage unit 51 and can be used by the moving image pattern model matching unit 57 when it performs processing.

An identification result output unit 58 is configured to perform processing for outputting the matching result obtained by the moving image pattern model matching unit 57. In the present exemplary embodiment, the identification result output unit 58 outputs the processing result of the moving image pattern model matching unit 57, which is the determination result indicating whether a moving image belongs to the predetermined category C. Then, the entire processing of the moving image pattern identification method according to the present exemplary embodiment terminates upon completing the determination result output processing. The processing to be performed by the identification result output unit 58 corresponds to an identification result output step S68 illustrated in illustrated in FIG. 6.

When the above-mentioned processing is performed, it becomes feasible to determine whether the input moving image data belongs to the predetermined category C. As mentioned above, the present exemplary embodiment is different from the first exemplary embodiment in extracting a plurality of pieces of time-sequential data based on the feature point tracing result. As mentioned above, the present invention is applicable to a method that includes tracing feature points in a moving image and extracting time-sequential data.

Further, although the time-sequential data extracted from the moving image data in the first exemplary embodiment is the only one type, it is useful to extract a plurality of different types of time-sequential data as described in the present exemplary embodiment. The time-sequential data to be extracted can include various types of data, such as time-sequential data of a local image feature and time-sequential data of a feature point displacement.

The method according to the present exemplary embodiment includes determining whether the input moving image data is a moving image that belongs to the predetermined category C. However, the present invention is not limited to the above-mentioned example. It is useful to identify the category of the input moving image data when there is a plurality of predetermined categories. An example method usable in this case includes obtaining the SVM identification model defined by the formula 3 for each of a plurality of predetermined categories beforehand and generating description data of the input moving image data by performing the above-mentioned sequential processing (including the processing by the description data generation unit 56) according to the present exemplary embodiment on the input moving image data. The method further includes calculating a value on the left side of the SVM identification model (i.e., the formula 3) obtained beforehand for each category, using the generated description data. The method further includes determining that the input moving image data belongs to a category corresponding to an identification model that is highest in the calculated left side value. In a case where the identification model is obtained for each of a plurality of categories, there may be a tendency that a value calculated using an identification model that corresponds to a specific category becomes higher than other values due to a deviation in the number of the moving image data used in the generation of identification models. In such a case, it is useful to add a unique bias “b_{c}” to the left side of the identification model for each category in such a way as to correct the above-mentioned tendency, as indicated by the following formula.

Σ_{SV}_{_{c}}α_{SV}_{_{c,j}}·k(x,x_{(SV}_{_{c,j}}₎)+β_{c}+b_{c}

In the formula 7, x_{(SVc, j)} represents the j-th support vector in the identification model that belongs to the category c, “β_{SVc}, j” represents a coupling coefficient corresponding to the j-th support vector, and β_{c} is a bias item. Further, Σ_{SVc} represents the sum total of all support vectors in the identification model that belongs to the category c. The unique bias “b_{c}” of each category can be determined, for example, using a cross-validation (e.g., 5 Fold Cross-Validation), similar to the soft margin parameter of the SVM. As mentioned above, it is feasible to identify the category of the input moving image data when there is a plurality of predetermined categories.

A moving image data clustering method according to a third exemplary embodiment of the present invention includes generating respective description data of a plurality of moving image data group including moving image data using the moving image information processing method described in the first or second exemplary embodiment, and clustering the moving image data using the generated description data. The clustering in the present exemplary embodiment means a grouping of a plurality of pieces of moving image data.

The present exemplary embodiment includes some features that are similar to those described in the first and second exemplary embodiments, and therefore redundant description thereof will be avoided.

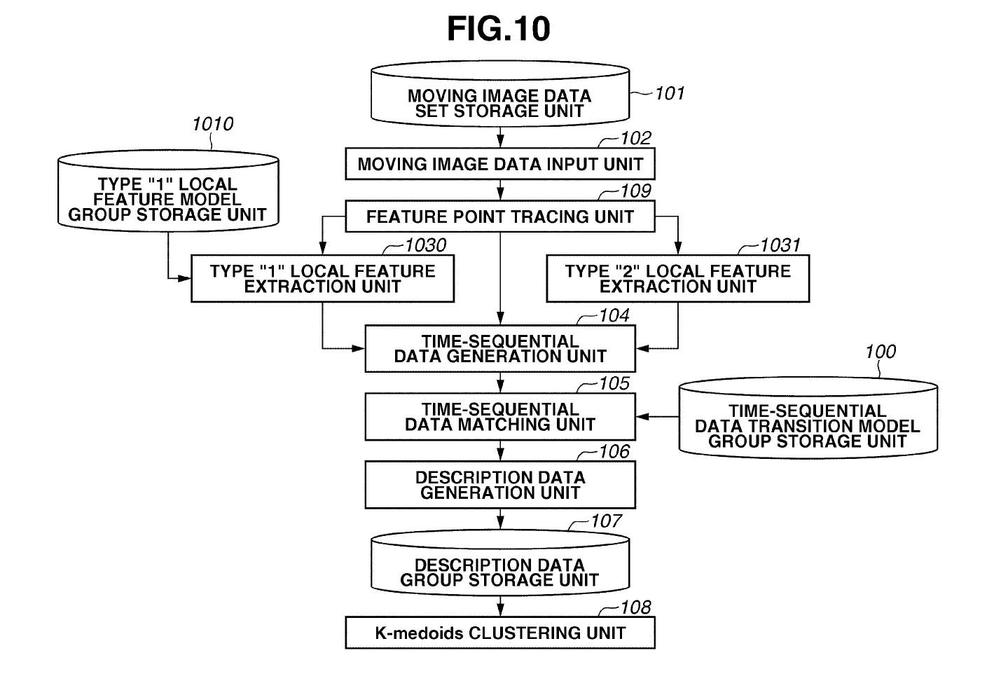

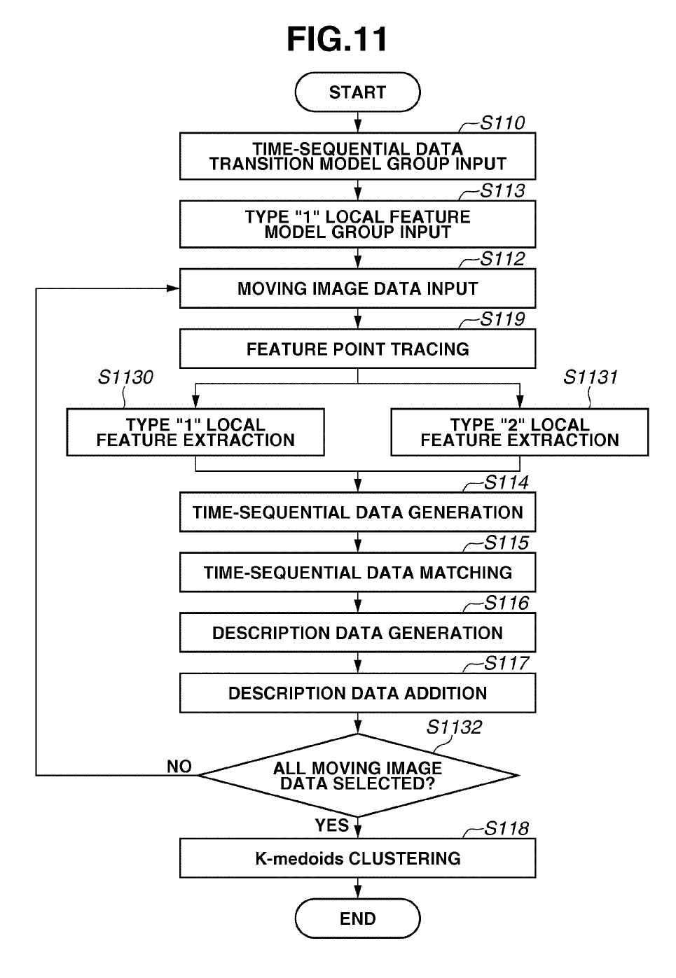

FIG. 10 is a diagram illustrating example processing blocks of the moving image data clustering method according to the present exemplary embodiment. FIG. 11 is a flowchart illustrating example processing of the moving image data clustering method according to the present exemplary embodiment. An example of the moving image data clustering method according to the present exemplary embodiment is described in detail below with reference to FIGS. 10 and 11.

A time-sequential data transition model group storage unit 100 is a data storage unit configured to store numerous time-sequential data transition models that correspond to the time-sequential data in the present exemplary embodiment. The time-sequential data transition models used in the present exemplary embodiment are the HMM data. The present exemplary embodiment is different from other exemplary embodiments in that numerous time-sequential data to be extracted from the moving image data are time-sequential data having discrete values, as described below. Therefore, an emission probability function of the HMM data used in the present exemplary embodiment is a probability density function that uses discrete variables as a domain. In the present exemplary embodiment, the time-sequential data transition model group storage unit 100 can store 400 pieces of HMM data while allocating an index to each HMM data. The processing to be performed by the time-sequential data transition model group storage unit 100 corresponds to a time-sequential data transition model group input step S110 illustrated in FIG. 11.

A type “1” local feature model group storage unit 1010 is a data storage unit configured to store Visual Codewords data that relate to type “1” local features in the present exemplary embodiment. The Visual Codewords used in the present exemplary embodiment are Visual Codewords of Motion Boundary Histogram (MBH) features discussed in non-patent literature document entitled “Human Detection using Oriented Histograms of Flow and Appearance”, by Dalal, N., B. Triggs and C. Schmid, IEEE European Conference on Computer Vision, Vol. 2, pp. 428-441, 2006.

The Visual Codewords of the MBH features can be generated by extracting numerous MBH features from numerous moving image data beforehand and then performing clustering processing on the extracted MBH features according to an appropriate clustering method (e.g., K-means method). The type “1” local feature models used in the present exemplary embodiment are Visual Codewords including 1000 MBH features. Therefore, the type “1” local feature model group storage unit 1010 receives and stores Visual Codewords data of 1000 MBH features that have index numbers 1 to 1000 allocated beforehand. The processing to be performed by type “1” local feature model group storage unit 1010 corresponds to a type “1” local feature model group input step S113 illustrated in FIG. 11.

A moving image data input unit 102 is configured to successively perform processing for selectively receiving a moving image data group from a moving image data set storage unit 101. The processing to be performed by the moving image data input unit 102 corresponds to a moving image data input step S112 illustrated in FIG. 11. As illustrated in FIG. 11, the moving image data input unit 102 repetitively receives moving image data until the generation of description data that correspond to each moving image data completes for all moving image data stored in the moving image data set storage unit 101.

A feature point tracing unit 109 is a processing unit that is similar to the feature point tracing unit 59, which is described in the second exemplary embodiment with reference to FIG. 5, and is configured to extract numerous feature point tracing results from the input moving image data. A type “2” local feature extraction unit 1031 is similar to the type “2” local feature extraction unit 531, which is described in the second exemplary embodiment with reference to FIG. 5, and is configured to extract displacement features at each feature point. The processing to be performed by the feature point tracing unit 109 and the type “2” local feature extraction unit 1031 corresponds to a feature point tracing step S119 and a type “2” local feature extraction step S1131 illustrated in FIG. 11. Details of the processing to be performed by these units are similar to those described in the second exemplary embodiment and therefore redundant description thereof will be avoided.

A type “1” local feature extraction unit 1030 is configured to extract local features having the center positioned at each feature point obtained by the feature point tracing unit 109, similar to the type “1” local feature extraction unit 530 described in the second exemplary embodiment with reference to FIG. 5. However, the type “1” local feature extraction unit 1030 is different from that of the second exemplary embodiment in the format of local features to be extracted.

More specifically, in the present exemplary embodiment, first, the type “1” local feature extraction unit 1030 extracts MBH features in a local area having the center positioned at each feature point. Then, the type “1” local feature extraction unit 1030 obtains a Visual Codeword index that corresponds to the extracted MBH features based on the Visual Codewords data of the MBH features stored in the type “1” local feature model group storage unit 1010. The type “1” local feature extraction unit 1030 can acquire the Visual Codeword index, for example, by searching for a Visual Codeword closest to the MBH features extracted with a standard of the Euclidean distance or the chi-square distance and identifying an index that corresponds to the acquired Visual Codeword.

Then, the type “1” local feature extraction unit 1030 sets the obtained index as the type “1” local features at the concerned feature point. The total number of the Visual Codewords used in the present exemplary embodiment is 1000. Therefore, any one of index numbers 1 to 1000 is allocated to each of the type “1” local features. The type “1” local feature extraction unit 1030 obtains the above-mentioned type “1” local features for all feature points obtained by the feature point tracing unit 109. The processing to be performed by the type “1” local feature extraction unit 1030 corresponds to a type “1” local feature extraction unit 1130 illustrated in FIG. 11.

A time-sequential data generation unit 104 is configured to generate time-sequential data that corresponds to each feature point tracing result based on the feature point tracing result obtained by the feature point tracing unit 109 and two types of local features extracted by the type “1” local feature extraction unit 1030 and the type “2” local feature extraction unit 1031. The processing to be performed by the time-sequential data generation unit 104 corresponds to a time-sequential data generation step S114 illustrated in FIG. 11. One piece of time-sequential data generated in the present exemplary embodiment is time-sequentially disposed combinations of the type “1” local features and the displacement features that correspond to respective feature points in the same feature point tracing result. As mentioned above, the type “1” local features according to the present exemplary embodiment are discrete values ranging from 1 to 1000, and the displacement feature is one of the five quantized patterns. Therefore, the time-sequential data are discrete time-sequential data having 5000 (=1000×5) possibilities.

A time-sequential data matching unit 105 is configured to perform matching of the time-sequential data and a plurality of time-sequential data transition models stored in the time-sequential data transition model group storage unit 100, similar to the time-sequential data matching unit 15 described in the first exemplary embodiment with reference to FIG. 1. Then, the time-sequential data matching unit 105 performs processing for identifying the most closely matched time-sequential data transition model for each time-sequential data generated by the time-sequential data generation unit 104 and obtaining an index of the most closely matched time-sequential data transition model. The processing to be performed by the time-sequential data matching unit 105 corresponds to a time-sequential data matching step S115 illustrated in FIG. 11. Similar to the first exemplary embodiment, 400 time-sequential data transition models used in the present exemplary embodiment are the HMM data. As mentioned above, the emission probability function of the HMM data is a probability density function that uses discrete variables as a domain. Similar to other exemplary embodiments, a plurality of pieces of HMM data can be obtained using the above-mentioned time-sequential data extracted from numerous moving image data, according to a method similar to that applied to the time-sequential data transition models in the first exemplary embodiment.

A description data generation unit 106 is configured to perform processing for generating description data of the moving image data based on the processing result obtained by the time-sequential data matching unit 105. The processing to be performed by the description data generation unit 106 corresponds to a description data generation step S116 illustrated in FIG. 11. The present exemplary embodiment is different from other exemplary embodiments in that the description data generated by the description data generation unit 106 is an element data list that stores a set of an index of a time-sequential data transition model that most closely matches each time-sequential data and positional information of the time-sequential data, not the description data of a BoW expression.

The positional information of the time-sequential data used in the present exemplary embodiment is a starting point position of a corresponding to feature tracing result. For example, when “i” represents the index of a time-sequential data transition model that corresponds to a concerned time-sequential data and (u₀, v₀) represents the starting point position of the feature tracing result that corresponds to the time-sequential data, an element data (i, u₀, v₀) expresses the time-sequential data. The description data of the moving image data in the present exemplary embodiment is a list including an array of the above-mentioned element data obtained for all time-sequential data (although the order is arbitrary).

More specifically, in a case where 4000 pieces of time-sequential data are extracted from a processing target moving image data, the description data of the moving image data obtained in this case is a list including 4000 pieces of element data (i.e., index, starting point position u, and starting point position v) as mentioned above. Then, a description data group storage unit 107 cumulatively stores the generated description data that corresponds to each moving image data. The processing to be performed by the description data group storage unit 107 corresponds to a description data addition step S117 illustrated in FIG. 11. When the above-mentioned processing has been completed for all moving image data stored in the moving image data set storage unit 101 (Yes in step S1132), description data that corresponds to each moving image data can be stored in the description data group storage unit 107. In the present exemplary embodiment, as mentioned above, only one time-sequential data transition model that most matches each time-sequential data is determined.

However, similar to the second exemplary embodiment, it is useful to obtain a conformity degree that corresponds to each time-sequential data transition model and generate a list of data having the conformity degree greater than a predetermined value, to obtain the description data of the moving image data.

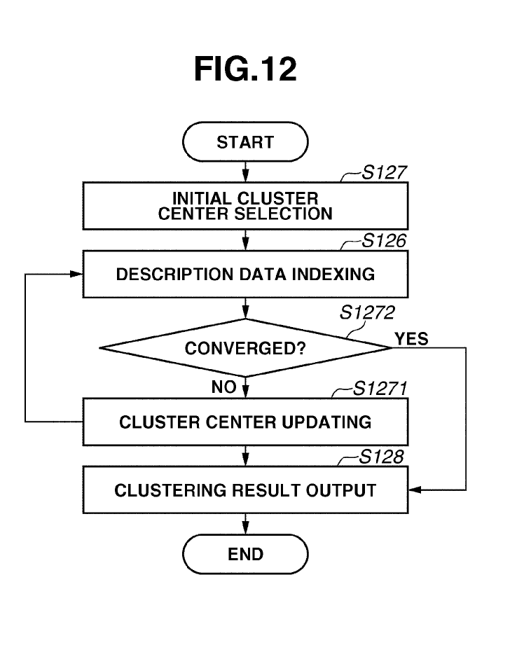

When the description data that corresponds to each moving image data has been recorded through the above-mentioned processing, a K-medoids clustering unit 108 performs clustering processing on the recorded data and outputs a result of the clustering processing. The processing to be performed by the K-medoids clustering unit 108 corresponds to a K-medoids clustering step S118 illustrated in FIG. 11. The entire processing of the moving image data clustering method according to the present exemplary embodiment completes upon completing the above-mentioned processing. The clustering processing used in the present exemplary embodiment is a K-medoids method similar to the method used in the type “2” time-sequential data transition model generation processing in the second exemplary embodiment. FIG. 12 is a flowchart illustrating example processing that can be performed by the K-medoids clustering unit 108. An example of the processing that can be performed by the K-medoids clustering unit 108 is described in detail below with reference to FIG. 12.

In an initial cluster center selection step S127, the K-medoids clustering unit 108 randomly selects some description data corresponding to each moving image data, by an amount corresponding to the number of generated cluster data (e.g., K pieces), from the description data stored in the description data group storage unit 107. Then, the K-medoids clustering unit 108 stores the selected description data as an initial cluster center while allocating an index to the selected description data.

Next, in a description data indexing step S126, the K-medoids clustering unit 108 obtains a current distance between each description data stored in the description data group storage unit 107 and each cluster center. Then, the K-medoids clustering unit 108 performs processing for allocating an index that corresponds to the closest cluster center to each description data. At this moment, if the index allocated to each description data is identical to the previously allocated index (Yes in step S1272), the K-medoids clustering unit 108 determines that the processing has been converged. The operation proceeds to a clustering result output step S128. If the allocated index is different from the previously allocated index (No in step S1272), the K-medoids clustering unit 108 determines that the processing is not yet converged. The operation proceeds to a cluster center updating step S1271. In the present exemplary embodiment, the distance between each description data and each cluster center can be any other value if it indicates a non-similarity between two description data. In the present exemplary embodiment, the following formula is usable to define a similarity Sim (A, B) between two description data A and B.

$$Sim ( A , B ) = \frac{1}{{L}_{A} + {L}_{B}} [ {\sum }_{m = 1}^{{L}_{A}} {max}_{n = 1 ∼ {L}_{B}} δ ( {}_{}^{A}{E}{}_{i}^{( m )} , {}_{}^{B}{E}{}_{i}^{( n )} ) {w}_{d} ( {}_{}^{A}{E}{}_{}^{( m )} , {}_{}^{B}{E}{}_{}^{( n )} ) + {\sum }_{n = 1}^{{L}_{B}} {max}_{m = 1 ∼ {L}_{A}} δ ( {}_{}^{B}{E}{}_{i}^{( n )} , {}_{}^{A}{E}{}_{i}^{( m )} ) {w}_{d} ( {}_{}^{B}{E}{}_{}^{( n )} , {}_{}^{A}{E}{}_{}^{( m )} ) ] \\ {w}_{d} ( {}_{}^{A}{E}{}_{}^{( m )} , {}_{}^{B}{E}{}_{}^{( n )} ) = exp \{ - \frac{{( {}_{}^{A}{E}{}_{u}^{( m )} - {}_{}^{B}{E}{}_{u}^{( n )} )}^{2} + {( {}_{}^{A}{E}{}_{v}^{( m )} - {}_{}^{B}{E}{}_{v}^{( n )} )}^{2}}{2 {σ}^{2}} \} \qquad [ formula 8 ]$$

In the above-mentioned formula 8, L_{A} represents the number of element data in the list of description data A and L_{B} represents the number of element data in the list of description data B. Further, ^{A}E^{(m)} represents m-th element data of the description data A and ^{A}Eᵢ^{(m)} represents index information of the element data, which indicates a time-sequential data transition model corresponding to the time-sequential data that corresponds to the element data. Further, ^{A}Eᵤ^{(m)} and ^{A}Eᵥ^{(m)} are positional information of the element data and “w_{d}” is a weighting term that is based on the L2 norm of the positional information. Further, δ(i, j) represents the kronecker delta that equals 1 when i=j and equals 0 otherwise.

More specifically, the above-mentioned formula indicates the sum total of weighted positional differences between respective element data and corresponding element data (i.e., element data that have the same index information and is closest in positional information), which is normalized by the total number element data. In the weighting term, σ can be set according to the image size. In the present exemplary embodiment, σ=10. More specifically, a weighting of approximately 0.6 is given when a shift in position is approximately 10 pixels. In the present exemplary embodiment, the following formula is usable to define a distance D (A, B) between two description data A and B using the above-mentioned similarity.

$$D ( A , B ) = \frac{1 - Sim ( A , B )}{Sim ( A , B )} \qquad [ formula 9 ]$$

In the present exemplary embodiment, in the description data indexing step S126, the K-medoids clustering unit 108 uses the above-mentioned distance definition to perform processing for allocating an index that corresponds to the closest cluster center.

In the clustering center updating step S1271, the K-medoids clustering unit 108 updates the corresponding cluster center using an assembly of description data that are identical in the cluster allocated in the description data indexing step S126. In the present exemplary embodiment, similar to the type “2” time-sequential data transition model generation method using the K-medoids method in the second exemplary embodiment, the K-medoids clustering unit 108 selects a representative data from a plurality of description data that are identical in the allocated cluster and designates the selected description data as a new cluster center. The representative data to be selected in this case is smallest in the sum total of the above-mentioned distances from other description data in the description data group identical in the allocated cluster.

More specifically, in the second exemplary embodiment, the matching cost of the DP matching is used to define the distance. On the other hand, in the present exemplary embodiment, the K-medoids clustering unit 108 performs similar processing using the above-mentioned distances, instead of using matching costs.

If it is determined that the processing in the description data indexing step S126 has been converged (Yes in step S1272), then in the clustering result output step S128, the K-medoids clustering unit 108 outputs the clustering result. The entire processing of the moving image data clustering method according to the present exemplary embodiment terminates upon completing the output of the clustering result. The clustering result to be output in this case indicates the grouping of respective description data, as a clustering result of the moving image data.

The above-mentioned processing can realize the clustering of numerous moving image data. As mentioned above, the present invention is applicable to a method that performs clustering on moving image data based on the description data of the moving image data. Further, as described in the present exemplary embodiment, it is feasible to use description data including positional information, as the description data of the moving image data, different from the BoW format in other exemplary embodiment. Further, as described in the present exemplary embodiment, the time-sequential data to be extracted from the moving image data can be sequential data that integrate the MBH features and the displacement features (i.e., different modal local features).

A moving image pattern identification method according to a fourth exemplary embodiment of the present invention is a modified example of the moving image information processing method described in the second exemplary embodiment. Similar to the second exemplary embodiment, the moving image pattern identification method according to the present exemplary embodiment includes identifying one of a plurality of predetermined categories that corresponds to the input moving image data. In the present exemplary embodiment, the format of input moving image data is similar to that of the moving image data described in the first exemplary embodiment. The method according to the present exemplary embodiment includes identifying one of a plurality of specific sport scenes that corresponds to the moving image data. The present exemplary embodiment includes some features that are similar to those described in the second exemplary embodiment and therefore redundant description thereof will be avoided.

The present exemplary embodiment is similar to the second exemplary embodiment in its processing block configuration and processing flow. Therefore, an example of the moving image pattern identification method according to the present exemplary embodiment is described in detail below with reference to FIG. 5 and FIG. 6.

Similar to the second exemplary embodiment, the type “1” time-sequential data transition model group storage unit 500 and the type “2” time-sequential data transition model group storage unit 501 are data storage units configured to store a plurality of time-sequential data transition models, respectively. The time-sequential data transition models used in the second exemplary embodiment are the HMM data and the DP matching models. The time-sequential data transition models in the present exemplary embodiment are the HMM data, although the DP matching models are usable. In the second exemplary embodiment, the type “1” time-sequential data transition model group storage unit 500 stores 400 time-sequential data transition models and the type “2” time-sequential data transition model group storage unit 501 stores 100 time-sequential data transition models. However, the total number of the time-sequential data transition models is arbitrary, although it can be set to a value similar to that described in the second exemplary embodiment. Therefore, in the present exemplary embodiment, each of the type “1” time-sequential data transition model group storage unit 500 and the type “2” time-sequential data transition model group storage unit 501 stores 2000 time-sequential data transition models. The processing to be performed by the type “1” time-sequential data transition model group storage unit 500 and the type “2” time-sequential data transition model group storage unit 501 corresponds to the type “1” time-sequential data transition model group input step S600 and the type “2” time-sequential data transition model group input step S601 illustrated in illustrated in FIG. 6.

The present exemplary embodiment is different from the above-mentioned exemplary embodiments in that numerous time-sequential data transition models are used as mentioned above. In general, the amount of calculations tends to increase when numerous time-sequential data transition models are used. However, it is useful to improve the performance in identifying the category of the moving image data because of increase in the amount of information relating to the description data to be generated for input moving image data increases. The processing for generating numerous time-sequential data transition models is similar to the generation processing described in other exemplary embodiments. However, in a case where the time-sequential data transition models are the HMM data, the HMM model parameter updating processing becomes unstable if the number of time-sequential data required to generate the time-sequential data transition models is insufficient. In such a case, there is the higher possibility that the parameter updating processing can be of stabilized if a lower-limit value is set for each hidden state of the HMM data and for a peripheral posterior probability relating to the state transition.

The moving image pattern model storage unit 51 is a data storage unit configured to store moving image pattern models of a plurality of predetermined categories. In the present exemplary embodiment, as an example method for identifying the category of input moving image data, it is useful to prepare SVM data that correspond to respective categories and identify a category that corresponds to the SVM having a maximum output. Therefore, in the present exemplary embodiment, the moving image pattern model storage unit 51 stores identification model data of moving image patterns for each category, which can be generated using moving image data of each category learned beforehand and moving image belonging to a different category. The processing to be performed by the moving image pattern model storage unit 51 corresponds to the moving image pattern model input step S61 illustrated in FIG. 6.

The moving image data input unit 52, the feature point tracing unit 59, the type “1” local feature extraction unit 530, and the type “1” time-sequential data generation unit 540 are processing units similar to those described in the second exemplary embodiment, and therefore redundant description thereof will be avoided. The processing to be performed by the moving image data input unit 52, the feature point tracing unit 59, the type “1” local feature extraction unit 530, and the type “1” time-sequential data generation unit 540 corresponds to the moving image data input step S62, the feature point tracing step S69, the type “1” local feature extraction step S630, and the type “1” time-sequential data generation step S640 illustrated in illustrated in FIG. 6.

Similar to the second exemplary embodiment, the type “2” local feature extraction unit 531 performs processing for obtaining displacement features based on a change in each feature point position included in the feature point tracing result. Similar to the second exemplary embodiment, variation amounts of the displacement features can have quantized in the present exemplary embodiment. However, the displacement features to be obtained by the type “2” local feature extraction unit 531 in the present exemplary embodiment are continuous values, which are different from the quantized features in the second exemplary embodiment. For example, it is now presumed that a feature point position is (uₜ, vₜ) and the feature point position in the precedent frame is (uₜ₋₁, vₜ₋₁) in a feature point tracing result that includes the feature point. In this case, the variation amount is (uₜ−uₜ₋₁, vₜ−vₜ₋₁) and its two-dimensional continuous value data are displacement features. In the present exemplary embodiment, the starting point of the feature point tracing result is regarded as causing no change and therefore its displacement feature is constantly (0, 0). The processing to be performed by the type “2” local feature extraction unit 531 corresponds to the type “2” local feature extraction step S631 illustrated in illustrated in FIG. 6.

Subsequently, the type “2” time-sequential data generation unit 541 generates a plurality of pieces of type “2” time-sequential data based on the feature point tracing results obtained by the feature point tracing unit 59 and the displacement features obtained by the type “2” local feature extraction unit 531. The type “2” time-sequential data generation unit 541 generates one piece of time-sequential data for each feature point tracing result obtained by the feature point tracing unit 59. The processing to be performed by the type “2” time-sequential data generation unit 541 corresponds to the type “2” time-sequential data generation step S641 illustrated in illustrated in FIG. 6. Similar to the second exemplary embodiment, in the present exemplary embodiment, the one piece of time-sequential data to be generated by the type “2” time-sequential data generation unit 541 is a time-sequentially disposed displacement features that correspond to respective feature points in the same feature point tracing result. For example, it is now presumed that one feature point tracing result includes a tracing of feature points in 40 frames. Further, it is presumed that displacement features obtained by the above-mentioned displacement feature extraction unit 531 at respective feature points are d₁=(0, 0), d₂=(u₂−u₁, v₂−v₁), . . . , and d40=(u₄₀−u₃₉, v₄₀−v₃₉). In this case, the time-sequential data corresponding to the feature point tracing result is a time-sequentially disposed array of these 40 displacement features are regarded as two-dimensional vectors. The processing to be performed by the type “2” time-sequential data generation unit 541 corresponds to the type “2” time-sequential data generation step S641 illustrated in illustrated in FIG. 6.

The type “1” time-sequential data matching unit 550 is a processing unit that is similar to the time-sequential data matching unit 15 described in the first exemplary embodiment. More specifically, for each type “1” time-sequential data, the type “1” time-sequential data matching unit 550 obtains a likelihood of each of 2000 pieces of HMM data stored in the type “1” time-sequential data transition model group storage unit 500. Then, the type “1” time-sequential data matching unit 550 obtains an index of the HMM data that has the highest likelihood. The processing to be performed by the type “1” time-sequential data matching unit 550 corresponds to the type “1” time-sequential data matching step S650 illustrated in illustrated in FIG. 6. Similarly, for each type “2” time-sequential data, the type “2” time-sequential data matching unit 551 obtains a likelihood of each of 2000 pieces of HMM data stored in the type “2” time-sequential data transition model group storage unit 501. Then, the type “2” time-sequential data matching unit 551 obtains an index of the HMM data that has the highest likelihood. The processing to be performed by the type “2” time-sequential data matching unit 551 corresponds to a type “2” time-sequential data matching step S651 illustrated in illustrated in FIG. 6.

Similar to the second exemplary embodiment, the description data generation unit 56 performs processing for generating description data of the moving image data based on the processing results obtained by the type “1” time-sequential data matching unit 550 and the type “2” time-sequential data matching unit 551. In the present exemplary embodiment, the description data generation unit 56 generates two pieces of description data of description data x_{[1]} relating to the type “1” time-sequential data and description data x_{[2]} relating to the type “2” time-sequential data. Then, the description data generation unit 56 integrates the above-mentioned two types of description data as a description data {x}={x_{[1]}, x_{[2]}}. The two types of description data generated in this case are frequency data that are similar to the description data in the first exemplary embodiment or the time-sequential data relating to the type “2” time-sequential data in the second exemplary embodiment. The processing to be performed by the description data generation unit 56 corresponds to the description data generation step S66 illustrated in illustrated in FIG. 6. As mentioned above, 2000 pieces of time-sequential data transition models are used for each type in the present exemplary embodiment. Therefore, the description data generation unit 56 generates an array of 2000 numerical values as the frequency data for each type.

The moving image pattern model matching unit 57 performs matching of the description data generated by the description data generation unit 56 and the plurality of moving image pattern models stored in the moving image pattern model storage unit 51. The processing to be performed by the moving image pattern model matching unit 57 corresponds to the moving image pattern model matching step S67 illustrated in illustrated in FIG. 6. In the present exemplary embodiment, similar to the second exemplary embodiment, the moving image pattern model matching unit 57 performs SVM-based pattern identification processing. In this case, a kernel function that is similar to that described in the second exemplary embodiment can be used for the SVM. However, the kernel function used in the present exemplary embodiment can optimize the width of the kernel function considering the differences in the type and category, of respective time-sequential data, as defined by the following formula.

$$k ( \{ x \} , \{ {x}^{′} \} ) = exp \{ - {\sum }_{F = 1}^{2} \frac{1}{{ρ}_{C} {S}_{F}} {\sum }_{i = 1}^{2000} \frac{{( {x}_{[ F ] , i} - {x}_{[ F ] , i}^{′} )}^{2}}{{x}_{[ F ] , i} + {x}_{[ F ] , i}^{′}} \} \qquad [ formula 10 ]$$

In the formula 10, {x} represents is a set of two vectors x_{[1]} and x_{[2]}, and x_{[F]}, i represents an i-th element of a vector x_{[F]}. Further, ρ_{c} and S_{F} are parameters that determine the kernel width, in which and the parameter ρ_{c} determines whether the moving image data belongs to the category C for each SVM model. The parameter ρ_{c} can be optimized, for example, using the cross-validation (e.g., 5-Fold Cross-Validation). Further, S_{F} is an expected value of the chi-square distance between two data, which relates the vector x_{[F]}. The SVM identification model data used in the present exemplary embodiment can be generated using the above-mentioned kernel function according to a method similar to that described in the second exemplary embodiment. Then, the moving image pattern model matching unit 57 performs processing for obtaining a score relating to each category using the following formula.

Σ_{SV}_{_{C}}α_{SV}_{_{C,j}}·k({x},{x_{(SV}_{_{C,j}}₎})+β_{C}+b_{C}

In the above-mentioned formula 11, {x_{(SVC, j)}} represents a j-th support vector set in the identification model of the category C, α_{SVC}, j represents a coupling coefficient corresponding to the j-th support vector set, and β_{C} is a bias item. Further, Σ_{SVC} indicates the sum total of all support vector sets in the identification model of the category C, and “b_{C}” is a bias item unique to each category, which can be determined using the cross-validation (e.g., 5-Fold Cross-Validation) described in the second exemplary embodiment.

Finally, the identification result output unit 58 performs processing for outputting a determination result including the identified category of the input moving image data, based on the result obtained by the moving image pattern model matching unit 57. In the present exemplary embodiment, a plurality of SVM scores can be obtained by the moving image pattern model matching unit 57. Therefore, the determination result output by the identification result output unit 58 indicates that the input moving image data belongs to a category that corresponds to the highest SVM score. The entire processing of the moving image pattern identification method according to the present exemplary embodiment terminates upon completing the output of the determination result. The processing to be performed by the identification result output unit 58 corresponds to the identification result output step S68 illustrated in illustrated in FIG. 6. Through the above-mentioned processing, it becomes feasible to identify one of a plurality of predetermined categories that corresponds to the input moving image data.

In the above-mentioned exemplary embodiment, only one piece of description data is generated for a short moving image data. However, the present invention is not limited to the above-mentioned example. For example, it is useful to divide the moving image data into a plurality of segments that are temporally overlapped with each other and generate description data in respective segments, and further describe moving image data as time-sequential data of the description data. Further, it is useful to extract at least one piece of time-sequential data from the moving image data, instead of extracting a plurality of pieces of time-sequential data.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2012-055625 filed Mar. 13, 2012, which is hereby incorporated by reference herein in its entirety.

What is claimed is:

1. A moving image information processing method, comprising:
receiving moving image data;
extracting time-sequential data of local features from the moving image data;
receiving at least one time-sequential data transition model relating to the time-sequential data; and
generating description data that describes the moving image data based on the time-sequential data and the time-sequential data transition model.

2. The moving image information processing method according to claim 1, wherein the time-sequential data is time-sequentially arrayed data representing local features at predetermined fixed points of a plurality of frames of the moving image data or differences between the frames.

3. The moving image information processing method according to claim 1, wherein the time-sequential data is time-sequentially arrayed data representing local features at traced feature points obtained by tracing feature points included in the moving image data.

4. The moving image information processing method according to claim 1, wherein the time-sequential data transition model is a plurality of types of time-sequential data transition models, and the process of generating the description data includes performing matching of the time-sequential data and each of the plurality of types of time-sequential data transition models and obtaining description data based on the obtained matching result.

5. The moving image information processing method according to claim 1, wherein the time-sequential data transition model is a model in which a piece of predetermined data included in the time-sequential data has a dependence relationship with a piece of past data that is older than the predetermined data.

6. The moving image information processing method according to claim 4, wherein the time-sequential data transition model is a hidden Markov model.

7. The moving image information processing method according to claim 1, wherein the process of generating the description data includes performing matching of the time-sequential data and the time-sequential data transition model, calculating a frequency that the time-sequential data matches the time-sequential data transition model, and setting the calculated frequency as the description data of the moving image data.

8. The moving image information processing method according to claim 1, wherein the process of generating the description data includes performing matching of the time-sequential data and the time-sequential data transition model, calculating a conformity degree of the time-sequential data in relation to the time-sequential data transition model, and setting a cumulative value of calculated conformity degrees as the description data of the moving image data.

9. The moving image information processing method according to claim 1, wherein the process of generating the description data includes performing matching of the time-sequential data and the time-sequential data transition model, and generating a positional information list of the time-sequential data that matches the time-sequential data transition model as the description data of the moving image data.

10. The moving image information processing method according to claim 1, wherein the process of generating the description data includes performing matching of the time-sequential data and the time-sequential data transition model, and generating the description data of the moving image data that includes positional information of the time-sequential data together with a conformity degree of the time-sequential data in relation to the time-sequential data transition model as a list.

11. A moving image information processing method, comprising:
receiving a moving image data group including a plurality of pieces of moving image data;
extracting time-sequential data of local features from the moving image data included in the moving image data group;
receiving at least one time-sequential data transition model relating to the time-sequential data;
generating description data that describes the moving image data based on the time-sequential data and the time-sequential data transition model;
calculating a similarity between description data that correspond to respective moving image data; and
clustering each moving image data included in the moving image data group based on the calculated similarity.

12. A moving image pattern identification method, comprising:
executing the moving image information processing method according to claim 1;
receiving at least one moving image pattern model; and
identifying a moving image pattern of the moving image data by performing matching of the description data and the moving image pattern model.

13. A moving image information processing apparatus, comprising:
a unit configured to receive moving image data;
a unit configured to extract time-sequential data of local features from the moving image data;
a unit configured to receive at least one time-sequential data transition model relating to the time-sequential data; and
a unit configured to generate description data of the moving image data based on the time-sequential data and the time-sequential data transition model.

14. A moving image information processing apparatus, comprising:
a unit configured to receive a moving image data group including a plurality of pieces of moving image data;
a unit configured to extract time-sequential data of local features from the moving image data included in the moving image data group;
a unit configured to receive at least one time-sequential data transition model that relates to the time-sequential data;
a unit configured to generate description data of the moving image data based on the time-sequential data and the time-sequential data transition model;
a unit configured to calculate a similarity between description data that correspond to respective moving image data; and
a unit configured to cluster each moving image data included in the moving image data group based on the calculated similarity.

15. A moving image pattern identification apparatus, comprising:
the moving image information processing apparatus according to claim 13;
a unit configured to receive at least one moving image pattern model; and
a unit configured to identify a moving image pattern of the moving image data by performing matching of the description data and the moving image pattern model.

16. A computer readable storage medium that stores a program for causing a computer to execute the method according to claim 1.
